(19) United States
(12) Patent Application Publication
(10) Pub. No.: US 2015/0013920 A1
(43) Pub. Date: Jan. 15, 2015

(54) BATTERY POWERED VENETIAN AND ROMAN SHADE SYSTEM AND METHODS OF USE

(71) Applicant: QMotion Incorporated, Pensacola, FL (US)

(72) Inventors: Willis Jay Mullet, Gulf Breeze, FL (US); Dale McCarthy, Pensacola, FL (US); David Wayne Ward, Pensacola, FL (US)

(73) Assignee: QMotion Incorporated, Pensacola, FL (US)

(21) Appl. No.: 14/285,768

(22) Filed: May 23, 2014

Related U.S. Application Data
(60) Provisional application No. 61/844,212, filed on Jul. 9, 2013.

(51) Int. Cl. E06B 9/68; E06B 9/38

(52) U.S. Cl. CPC E06B 9/68; E06B 9/38; E06B 2009/6809
USPC 160/7; 160/405; 160/84.02; 160/168.1 R

(57) ABSTRACT

A Venetian shade and Roman shade assembly is presented having a header with a drive shaft assembly positioned in the header, the drive shaft having a plurality of lift and tilt spool assemblies. A motor controller assembly is removably positioned within the header and connected to the drive shaft assembly. The motor controller assembly includes a motor, a plurality of batteries and a motor controller that is wirelessly controllable by a remote. When the motor of the motor controller assembly is activated, the motor rotates the drive shaft assembly thereby raising or lowering the shade material as well as tilting the shade material.

### CROSS REFERENCE TO RELATED APPLICATION

This application claims the benefit of U.S. Provisional Application No. 61/844,212 filed Jul. 9, 2013.

### FIELD OF THE INVENTION

This invention relates to architectural coverings. More specifically, and without limitation, this invention relates to improvements to Venetian and Roman shades.

### BACKGROUND OF INVENTION

Architectural coverings are old and well known in the art. Modern architectural coverings come in countless sizes, shapes, configurations, colors, materials and designs, each of which are suited for their specific application. Some architectural coverings serve merely aesthetic purposes, so as to improve the aesthetic appearance of a window, door, room or the like. In contrast, other window coverings serve functional purposes such as blocking the glare of sunshine, or reducing the heat transfer through windows. Still other architectural coverings serve a combination of functional and aesthetic purposes.

The one form of architectural coverings, known as lift-type architectural coverings, or vertically opening architectural coverings are of particular interest in this application. Within this broad category of architectural coverings there are bottom opening, top opening and both bottom and top opening architectural coverings. Some of these architectural coverings are commonly referred to Venetian shades, Roman shades, honeycomb shades, slat shades, plantation shades, accordion shades, among countless other names.

Common components of these vertically opening architectural coverings include a header at their upper end which is attached a structure, such as a window frame, wall ceiling or the like. Shade material is connected to and extends downwardly from the header in a free hanging condition. A bottom bar is connected to the lower of shade material. Lift cords run through the shade material and connect header to bottom bar. In this arrangement, the shade material and bottom bar extend and retract vertically, in cooperation with the force of gravity by retracting or extending the lift cords.

While there have been many improvements to vertically opening shades, there are many deficiencies in the prior art. Namely, there is no commercially viable option for a battery powered motorized shade for use with Roman or Venetian shades. In addition, the battery life of commercially available vertically opening battery powered shades is insufficient. In addition, the commercially available battery powered window shades are bulky or lack aesthetics and therefore are not suitable for many applications. In addition, the commercially available battery powered window shades are not configurable to moving Venetian or Roman shades. In addition, the commercially available battery powered window shades lack the features and functionality needed to control the window shades for optimal performance.

For the reasons stated above, and for other reasons stated below which will become apparent to those skilled in the art upon reading and understanding the specification, there is a need in the art for an improved battery powered Venetian and Roman shade system and method of use.

Thus, it is a primary object of the invention to provide a battery powered Venetian and Roman shade system and method of use that improves upon the state of the art.

Another object of the invention is to provide battery powered Venetian and Roman shade system and method of use that provides improved functionality over the prior art.

Yet another object of the invention is to provide battery powered Venetian and Roman shade system and method of use that provides improved aesthetics over the prior art.

Another object of the invention is to provide battery powered Venetian and Roman shade system and method of use that provides quiet function.

Yet another object of the invention is to provide battery powered Venetian and Roman shade system and method of use that provides long battery life.

Another object of the invention is to provide battery powered Venetian and Roman shade system and method of use that is durable.

Yet another object of the invention is to provide battery powered Venetian and Roman shade system and method of use that is relatively inexpensive.

Another object of the invention is to provide battery powered Venetian and Roman shade system and method of use that that is easy to use.

Yet another object of the invention is to provide battery powered Venetian and Roman shade system and method of use that has a simple design.

Another object of the invention is to provide battery powered Venetian and Roman shade system and method of use that provides a long useful life.

Yet another object of the invention is to provide battery powered Venetian and Roman shade system and method of use that provides easy installation and access for maintenance and battery changes.

These and other objects, features, or advantages of the invention will become apparent from the specification and claims.

### SUMMARY OF THE INVENTION

A Venetian shade and Roman shade assembly is presented having a header with a drive shaft assembly positioned in the header, the drive shaft having a plurality of lift and tilt spool assemblies. A motor controller assembly is removably positioned within the header and connected to the drive shaft assembly. The motor controller assembly includes a motor, a plurality of batteries and a motor controller that is wirelessly controllable by a remote. When the motor of the motor controller assembly is activated, the motor rotates the drive shaft assembly thereby raising or lowering the shade material as well as tilting the shade material.

### BRIEF DESCRIPTION OF THE DRAWINGS

FIG. 1 is a perspective view of a vertically opening architectural covering having a header, a bottom bar and shade material extending there between with three sets of lift cords and tilt cords that extend from the header to the bottom bar that support, raise, lower and tilt the shade material, the view showing the fascia removed.

FIG. 2 is a side elevation view of a bottom bar with a lift cord adjustment device positioned in the bottom bar, the view showing the bottom bar fascia removed.

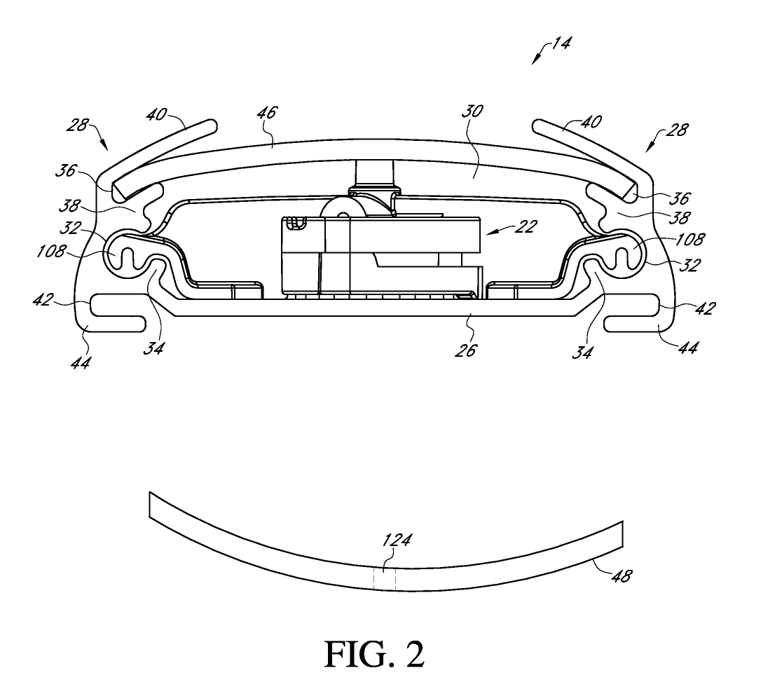

FIG. 3 is a perspective view of a bottom bar having a stiffener and a lift cord adjustment device therein, the view showing the through hole in the stiffener for the lift cord to pass through to reach the lift cord adjustment device.

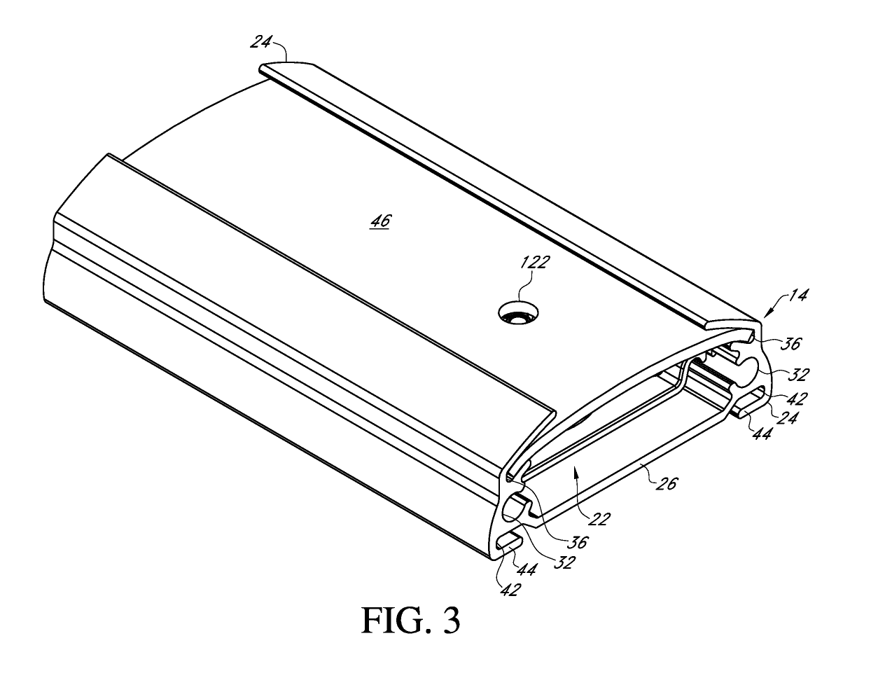

FIG. 4 is an elevation view of a spool of a lift cord adjustment device, the view showing a protrusion in the bottom of the spool for aligning in the access hole of the bottom of the bottom bar, and the opening in the axel of the spool for the lift cord to pass through.

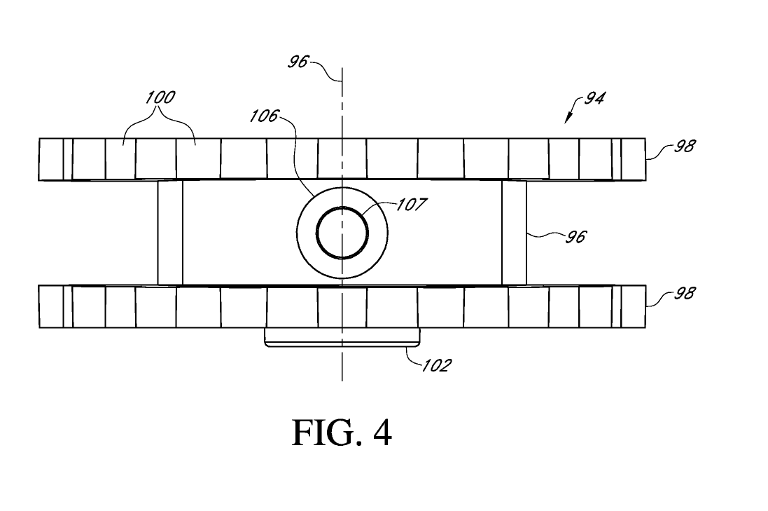

FIG. 5 is a perspective view of a spool for use with a lift cord adjustment device, the view showing the protrusion in the bottom of the spool for aligning in the access hole of the bottom of the bottom bar.

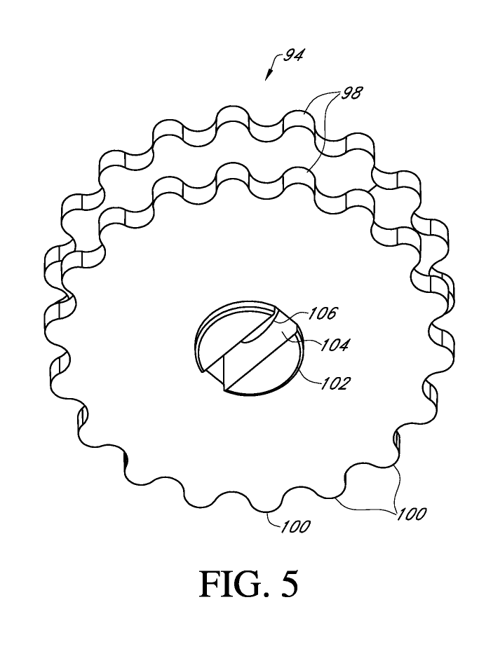

FIG. 6 is a side elevation view of a housing of a lift cord adjustment device.

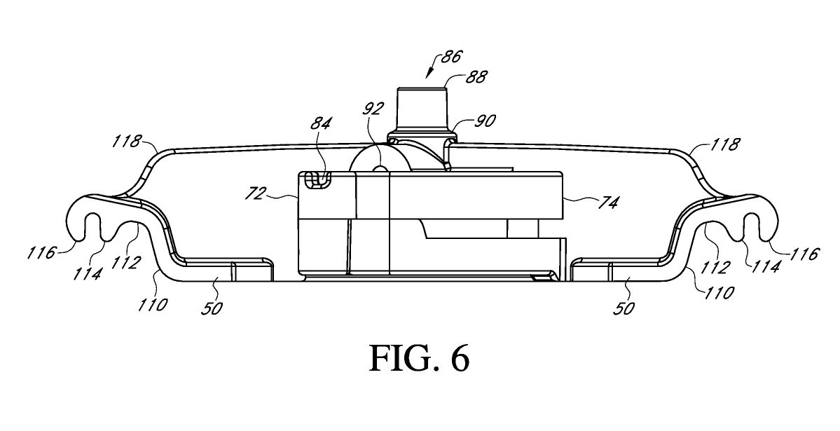

FIG. 7 is a bottom elevation view of a housing of a lift cord adjustment device, the view showing a flexible arm having teeth therein, and an alignment mechanism, the view also showing prongs which serve to force the spool downward as the lift cord is pulled.

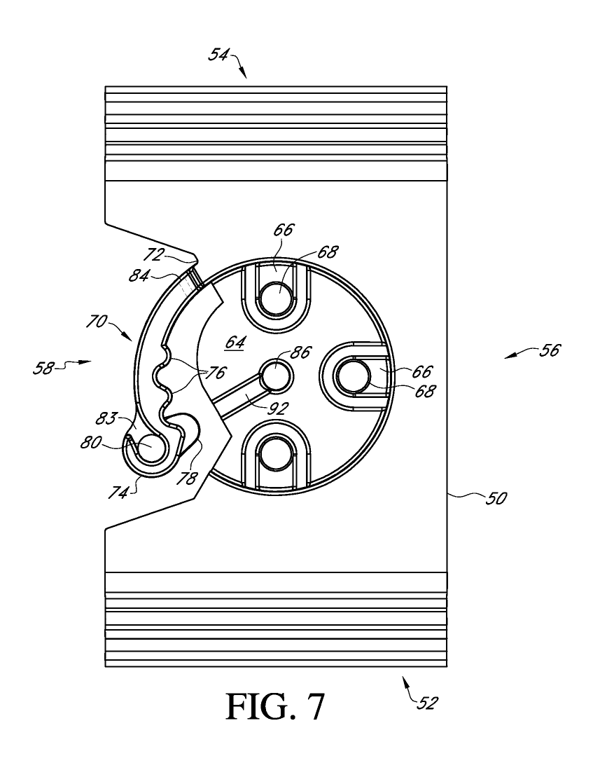

FIG. 8 is a perspective view of a housing of a lift cord adjustment device, the view showing a flexible arm having teeth therein, and an alignment mechanism, the view also showing prongs which serve to force the spool downward as the lift cord is pulled.

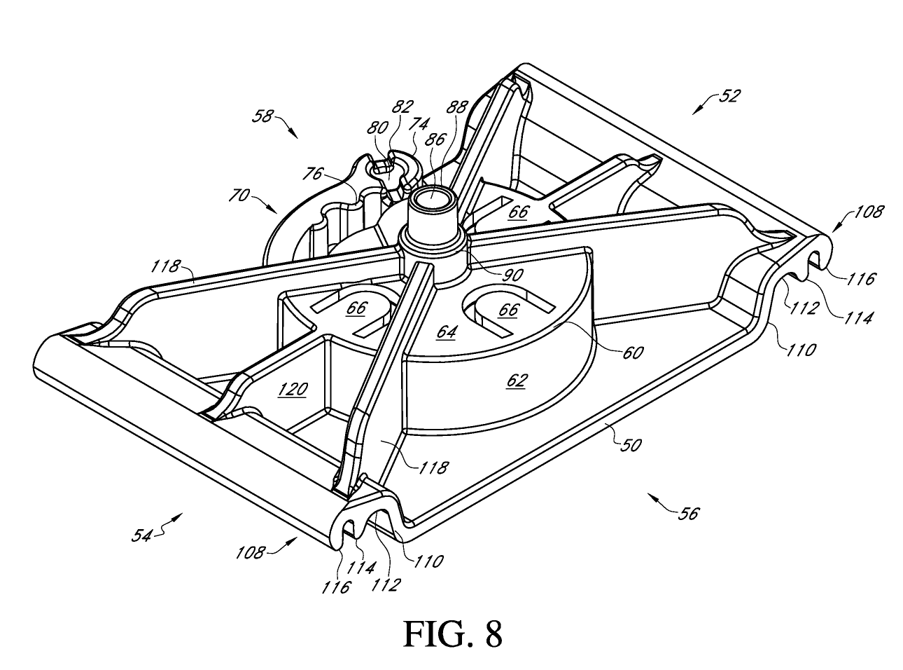

FIG. 9 is a perspective view of the bottom of a housing of a lift cord adjustment device, the view showing a recess for a spool, the view also showing the flexible arm having teeth therein, and an alignment mechanism, the view also showing prongs which serve to force the spool downward as the lift cord is pulled.

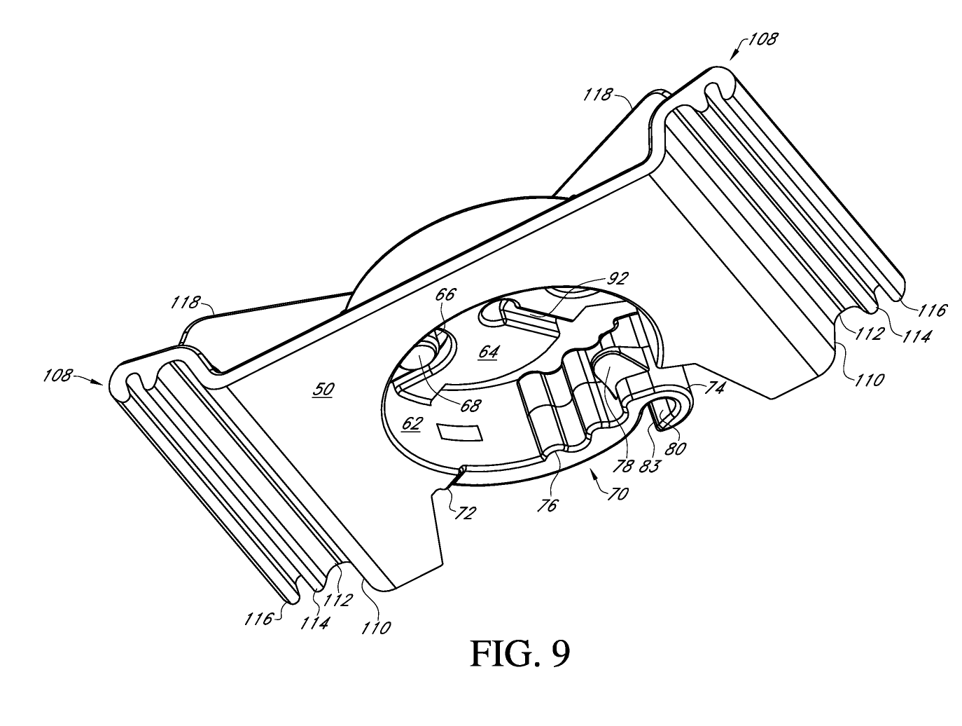

FIG. 10 is a top perspective view of a fully assembled lift cord adjustment device, the view showing the path of the lift cord through the housing, through the flexible arm and around the spool.

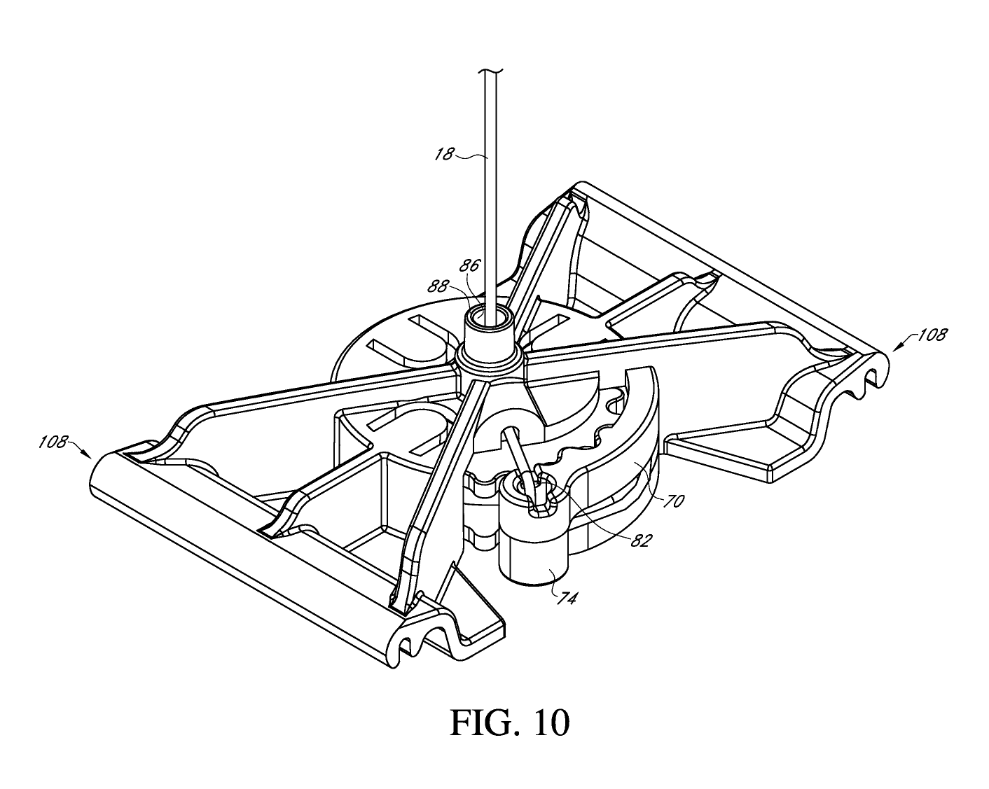

FIG. 11 is an exploded perspective view of an alternative arrangement of a lift cord adjustment device for use with Venetian shades, the view showing a collar which holds the lift cord adjustment device, the collar having vertical and horizontal openings which receive ends of a tilt ladder, the view also showing a cap which covers the lift cord adjustment device.

FIG. 12 is a perspective view of the lift cord adjustment device of FIG. 11, the view showing the lift cord adjustment device installed in a bottom bar.

FIG. 13 is a front elevation view of a Venetian shade with a fascia removed, the view showing the motor control assembly installed in the header and the drive shaft assembly having a plurality of spring housings and lift and tilt cord assemblies attached to the drive shaft.

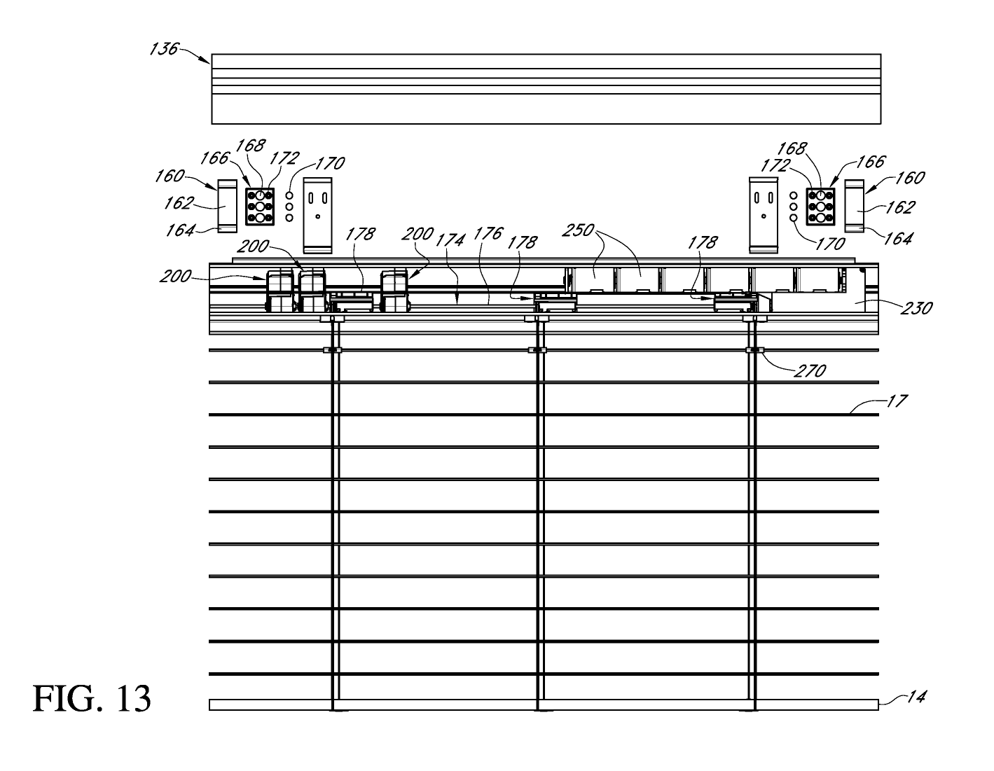

FIG. 14 is a perspective exploded view of a Venetian shade, the view showing the header, motor control assembly and drive shaft assembly, the drive shaft assembly having a plurality of spring housings and lift and tilt cord assemblies attached to the drive shaft.

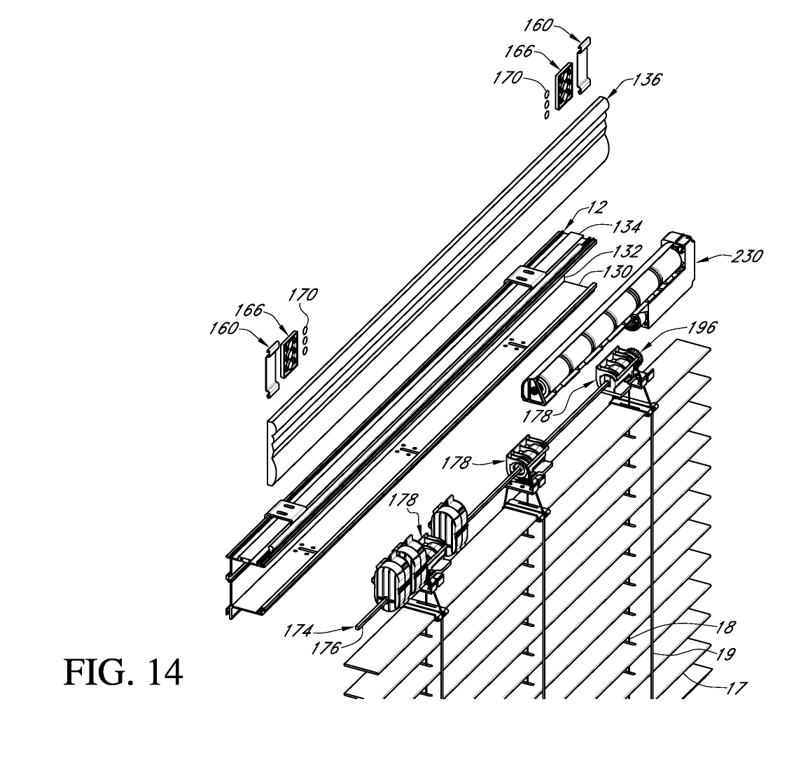

FIG. 15 is a close up perspective exploded view of a header of a Venetian shade, the view showing the header, motor control assembly and drive shaft assembly, the drive shaft assembly having a plurality of spring housings and lift and tilt cord assemblies attached to the drive shaft.

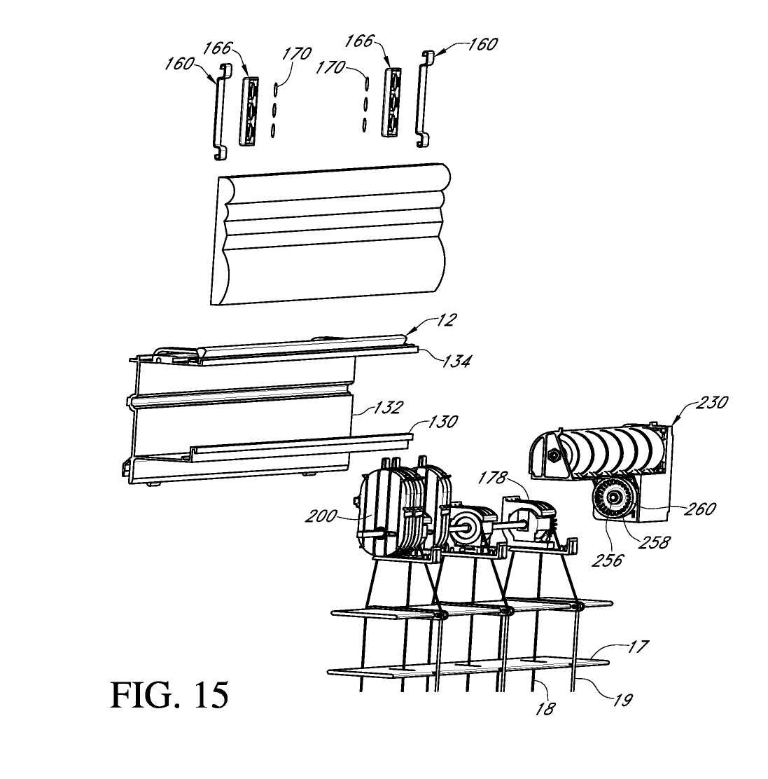

FIG. 16 is a perspective view of a motor controller assembly for use with a Venetian shade, the view showing a motor, motor controller, and a plurality of batteries housed in the motor housing, the view also showing a callout box identifying the components of the motor controller.

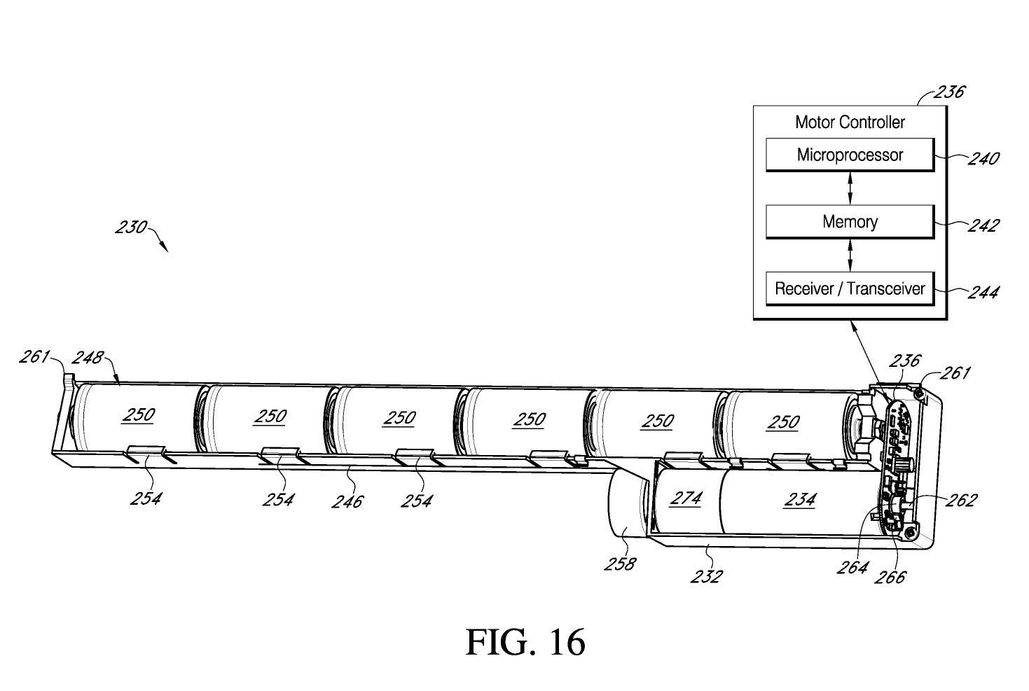

FIG. 17 is a perspective exploded view of the motor controller assembly of FIG. 16.

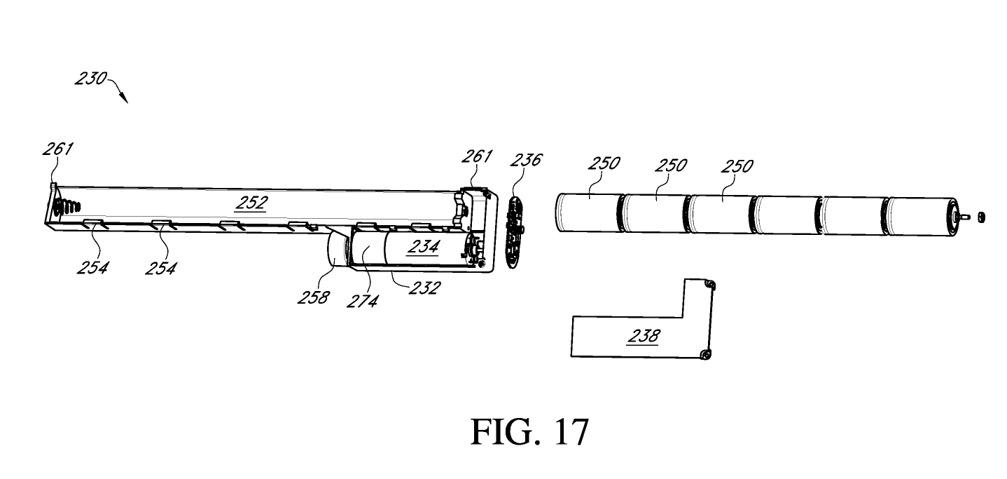

FIG. 18 is a close up perspective view of a drive shaft assembly having a drive adaptor connected to the end of a drive shaft adjacent a lift and tilt cord assembly, the view showing the top end of a tilt cord slightly raised off of tilt spool so as to show O-rings positioned in the groove of the tilt spool, the view also showing a slat clip attached to the first slat.

FIG. 19 is a close up perspective view of a slat clip connected to a slat, the view showing the ends of a tilt ladder extending into openings of the slat clip, and the view showing the lift cord extending through the slat clip.

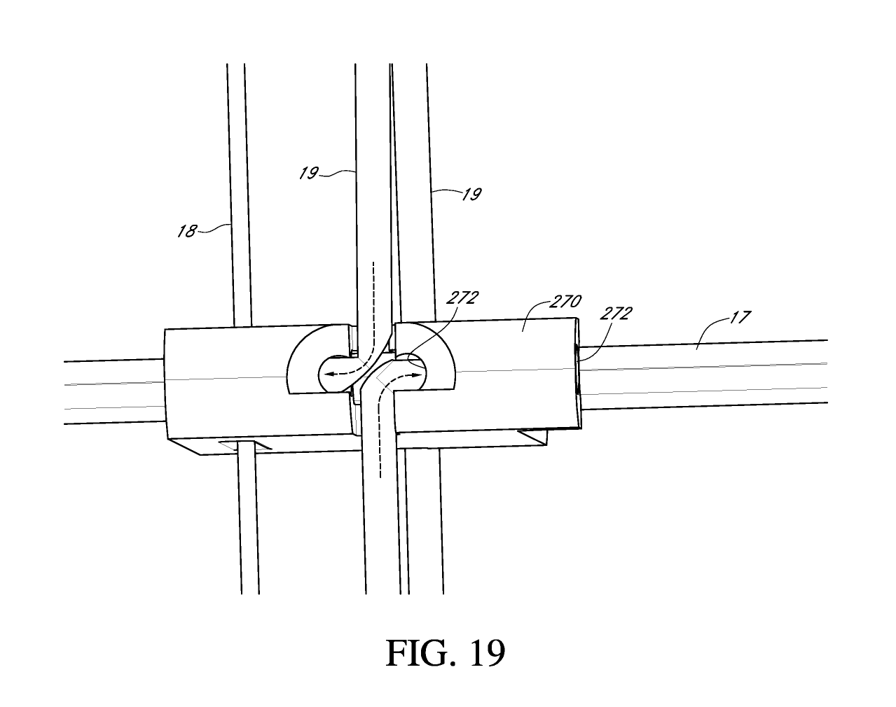

FIG. 20 is a close up perspective view of a spring housing, the view showing the first and second housing separated, and the spring in a standard wound condition, with the majority of the spring around the storage spool, therefore the spring housing is in the position it would be when the shade is raised.

FIG. 21 is a close up perspective view of a spring housing, the view showing the first and second housing separated, and the spring in a reverse wound condition, with the majority of the spring around the storage spool, therefore the spring is in the position it would be when the shade is lowered.

FIG. 22 is a side elevation view of a Venetian shade in a fully tilted down position, the view showing the spring housing positioned in the header.

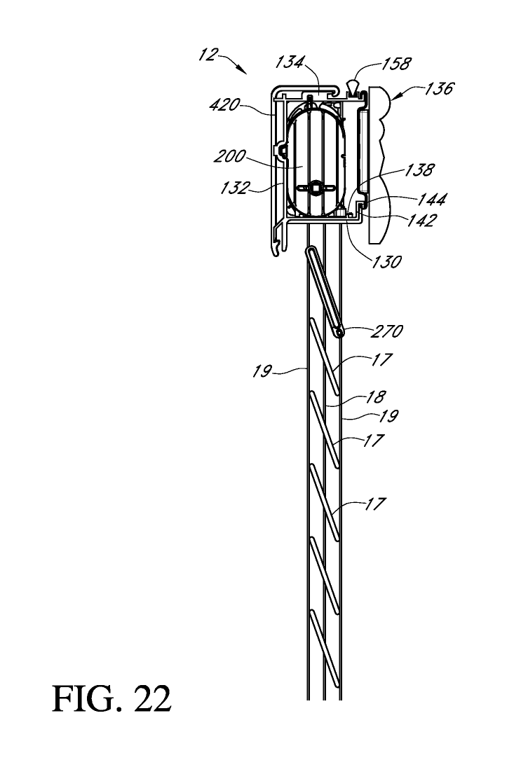

FIG. 23 is a side elevation view of a Venetian shade in a fully tilted up position, the view showing the spring housing positioned in the header.

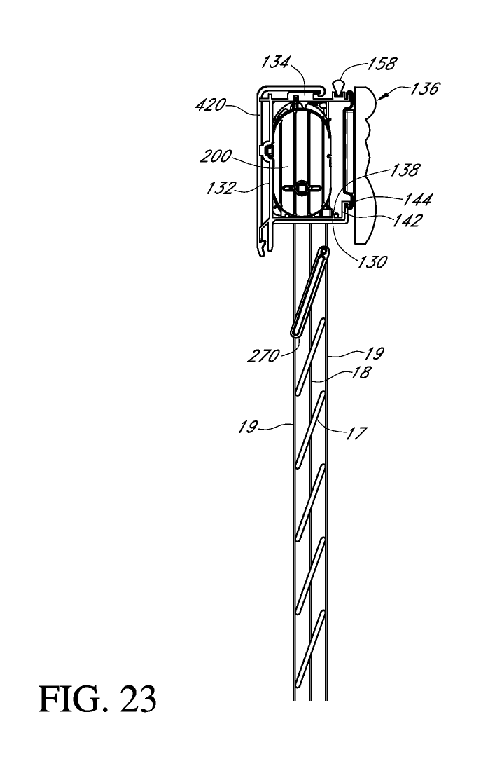

FIG. 24 is a side elevation close up view of the header, the view showing the motor controller assembly positioned within the header.

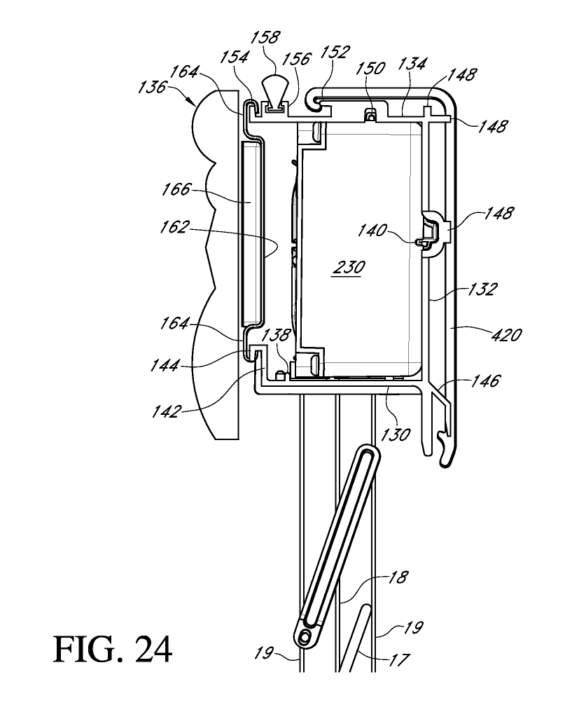

FIG. 25 is a side elevation close up view of the header, the view showing the spring housing positioned within the header.

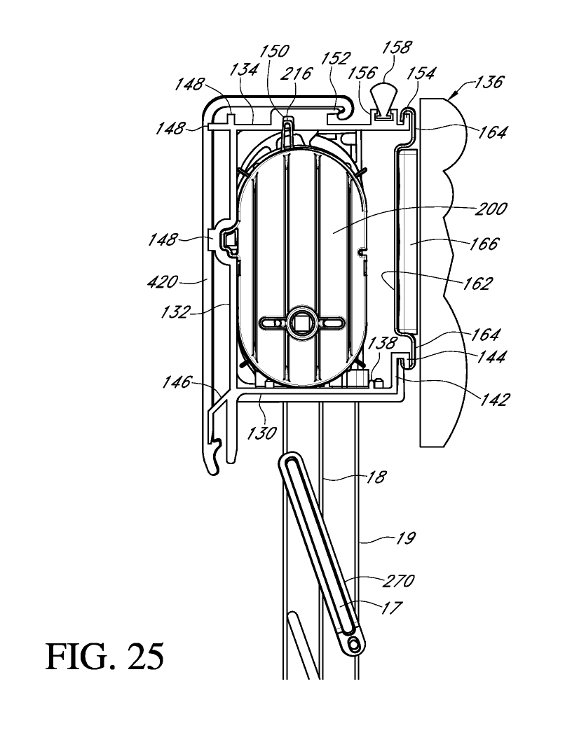

FIG. 26 is a side elevation view of a Roman shade in a partially opened position, the view showing the spring housing in the header, the shade material and the suspension cord extending through guides connected to support rods connected the shade material.

FIG. 27 is a rear elevation view of the Roman shade of FIG. 25, the view showing the shade in a partially opened position with the suspension cords extending through guides connected to support rods connected the shade material.

FIG. 28 is a side elevation view of the Roman shade of FIG. 25, the view showing the second corner guide roller and bracket.

FIG. 29 is a front elevation view of the Roman shade of FIG. 25 with the shade material removed, the view showing the components positioned within the header as well as the right lift cord being rerouted to make room for the motor control unit.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that mechanical, procedural, and other changes may be made without departing from the spirit and scope of the invention. The following detailed description is, therefore, not to be taken in a limiting sense, and the scope of the invention is defined only by the appended claims, along with the full scope of equivalents to which such claims are entitled.

As used herein, the terminology such as vertical, horizontal, top, bottom, front, back, end, sides, and the like, are referenced according to the views presented. It should be understood, however, that the terms are used only for purposes of description, and are not intended to be used as limitations. Accordingly, orientation of an object or a combination of objects may change without departing from the scope of the invention.

As used herein, the invention is shown and described as being used in association with an architectural covering. The term architectural covering is generic and includes any form of an architectural covering such as a shade, blind, drapery, roll shade, honeycomb shade, Venetian shade, Roman shade, or the like. In addition, the invention is not limited to use in architectural coverings, but can be used in any mechanical device.

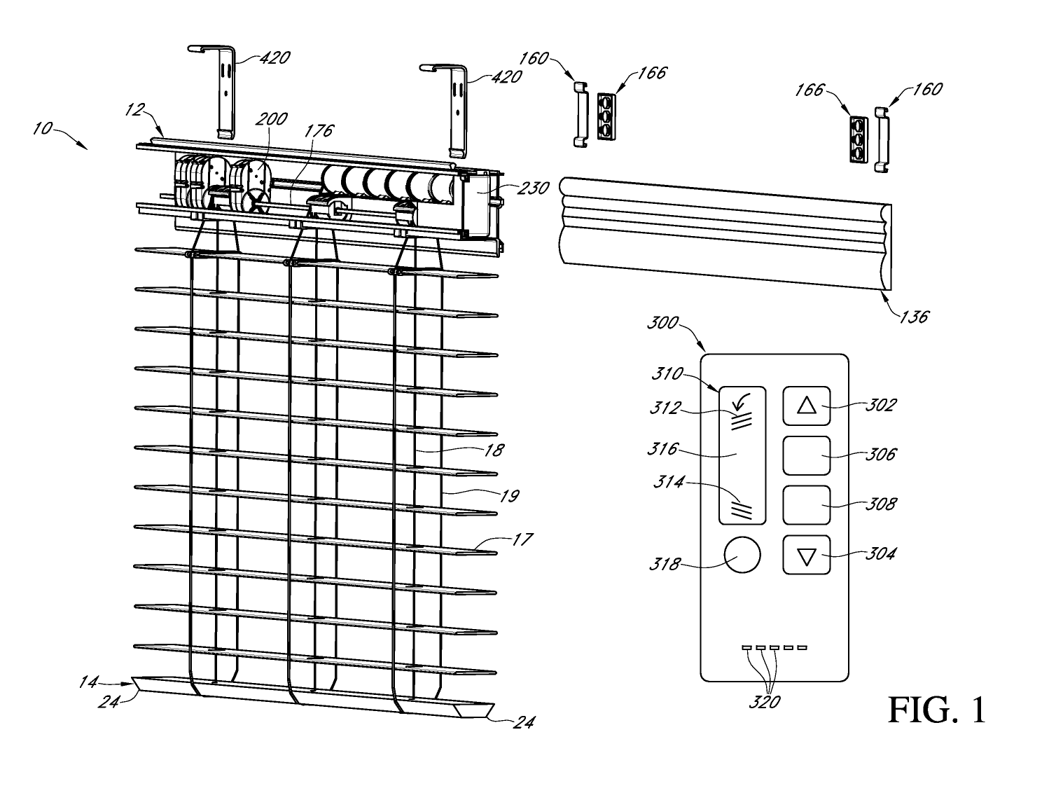

With reference to FIG. 1, a lift-type architectural covering, or vertically opening architectural covering 10 (hereinafter “architectural covering 10”) is presented. Architectural covering 10 includes a header 12 positioned at its upper end, a bottom bar 14 positioned at its lower end and shade material 16 that connects to and extends between the header 12 and the bottom bar 14. In one arrangement, shade material 16 is formed of a plurality of slats 17, such as is commonly known as a Venetian shade or plantation shade.

At least one lift cord 18 extends from the header 12 through the shade material 16 and into the bottom bar 14, and at least one tilt cord, tilt ladder or simply a “ladder” 19 extends from the header 12, around the slats 17 of the shade material 16 and into or around the bottom bar 14, each rung of the ladder 19 supporting a slat 17. In the arrangement shown, three lift cords 18 and extend through shade material 16 and three ladders 19 extend around the slats 17, to provide proper balance and durability to the architectural covering 10. Each outward lift cord 18 and ladder 17 is positioned inward from each side of shade material 16 a distance, with the center lift cord 18 and ladder 19 located centrally to the architectural covering 10. Shade material 16 and bottom bar 14 extend and retract vertically, in cooperation with the force of gravity by retracting or extending the lift cords 18. The upper end of lift cords 18 are retracted into and extend from inside the header 12, as is more fully described herein. The bottom end of lift cords 18 are connected to a lift cord adjustment device 22 which serves to adjust the length of the lift cords 18.

Lift Cord Adjustment Device:

Bottom bar 14 is formed of any suitable size, shape and design. In one arrangement, as is shown, bottom bar 14 is formed of a single piece of extruded material that extends a length between opposing ends 24. In another arrangement, bottom bar 14 is a solid piece of wood, plastic, or other composite material. In one arrangement, bottom bar 14 has a generally consistent size, shape and design throughout its length.

When viewed from its side, bottom bar 14 is generally symmetric in shape. Bottom bar 14 has a bottom wall 26 which extends between and connects opposing side supports 28. Bottom wall 26 is generally flat and planar in shape. Side supports 28 connect to the ends of bottom wall 26 and extend upwardly therefrom thereby defining a hollow interior 30 within the bottom bar 14.

Side supports 28 are formed of any suitable size, shape and design. In one arrangement, as is shown, side supports 28 have a plurality of openings which serve to receive and hold other components of the system. A first opening 32 is presented just above where the side supports 28 connect to bottom wall 26. First opening 32 is generally circular in shape when viewed from the side. A finger 34 extends upwardly adjacent first opening 32 thereby narrowing the passageway into first opening 32. Finger 34 also provides additional strength and rigidity to bottom bar 14 as well as providing an alignment feature and structural support for other components of bottom bar 14 as is described herein.

A second opening 36 is positioned just above the first opening 32. Second opening 36 is generally formed of an arcuate slot when viewed from the side. A divider 38 is positioned between first opening 32 and second opening 36. Divider 38 is generally Y-shaped and extends inwardly into the hollow interior 30 of bottom bar 14. The bottom arm of the Y of the Y-shaped divider 38 helps to define the upper portion of the first opening 32. The top arm of the Y of the Y-shaped divider 38 helps to define the bottom portion of the second opening 36. An upper flange 40 is connected to the upper end of second opening 36 and arcuately curves inwardly therefrom. Upper flange 40 extends inwardly past the other components of side supports 28.

A third opening 42 is positioned just below the first opening 32. Third opening 42 is generally formed of a rectangular slot when viewed from the side. The upper end of third opening 42 is defined by the bottom wall 26, which angles upwardly just before the third opening 42 and levels out in horizontal flat alignment to define the upper edge of third opening 42. A bottom flange 44 extends downwardly at the forward most edge of third opening prior to extending inwardly thereby defining the bottom edge of third opening 42. Bottom flange 44 extends downward in generally vertical alignment a distance before extending inward in generally horizontal alignment and in generally parallel spaced alignment with the bottom surface of the portion of bottom wall 26 within third opening 42.

A stiffener 46 is positioned within the second opening 36. Stiffener 46 is formed of any suitable size shape and design. In one arrangement, as is shown, stiffener 46 is formed of a generally planar or arcuately shaped elongated piece of material which is sized and shaped to fit within second opening 36. In one arrangement, when in position within second opening 36, stiffener curves slightly downward to engage the second opening 36. That is, when in position, stiffener 36 has a convex surface which faces upward and a concave surface which faces downward. In one arrangement, stiffener 46 is positioned within the bottom most cell of honeycomb when honeycomb shade material 16 is used, and in this way stiffener 46 serves to hold and align this honeycomb shade material 16 within bottom bar 14.

In one arrangement, a decorative bottom fascia 48 is positioned within the third opening 42. Fascia 48 is formed of any suitable size shape and design. In one arrangement, as is shown, fascia 48 is formed of a generally planar or arcuately shaped elongated piece of material which is sized and shaped to fit within third opening 42. In one arrangement, when in position within third opening 42, stiffener curves slightly upward to engage the third opening 42. That is, when in position, fascia 48 has a concave surface which faces upward and a convex surface which faces downward. In this way, fascia 48 refines the look and feel of bottom bar 14. However, in other arrangements, third opening 42 and fascia 48 are unnecessary and not present.

A lift cord adjustment device 22 is positioned within the hollow interior 30 of bottom bar 14 and aligned with each of the lift cords 18 that enter bottom bar 14. Lift cord adjustment device 22 is formed of any suitable size, shape and design. In one arrangement, as is shown, lift cord adjustment device 22 has a bottom wall 50 which is generally flat or planar in shape having a front side 52, an opposing rear side 54, a first lateral side 56 and an opposing lateral side 58.

A socket 60 extends upwardly from bottom wall 50 with a generally cylindrical sidewall 62 which terminates or is closed by an upper wall 64. Socket 60 is generally centrally positioned within bottom wall 50. While socket 60 is generally cylindrical in shape, with sidewall 62 defining approximately three quarters of the generally cylindrical shape. That is, sidewall 62 arcuately wraps around from front side 52, through first lateral side 56 and through rear side 58 thereby leaving second lateral side 58 open or partially open.

A plurality of prongs 66 are positioned within the upper wall 64. Prongs 66 are formed of any suitable size, shape and design. In one arrangement, as is shown, prongs 66 are formed out of U-shaped cut-out portions of upper wall 64 which point inwardly toward one another. A protrusion 68 is positioned at the point of each prong 66 and extends downwardly into the open interior of socket 60. In the arrangement shown, three prongs 66 are positioned in the upper wall 56, one on the front side 52 of upper wall 64, pointing rearward, one on the rear side 54 of upper wall 64 pointing forward, and one on the first lateral side 56 pointing towards the second lateral side 58.

A flexible arm 70 is connected to the second lateral side 58 and generally continues the arcuate curvature of sidewall 62 of socket 60 thereby generally closing the open end of socket 60. Flexible arm 70 connects at its base 72 adjacent the sidewall 62 of socket 60 adjacent the rearward side 54 and extends forward to where it terminates in its free end 74. Flexible arm 70 has at least one and as is shown a plurality of teeth 76 along its inward side which extend inwardly therefrom. Teeth 76 generally extend the vertical height of flexible arm 70.

At least one alignment feature 78 is connected to flexible arm 70 and also extends inwardly therefrom. In the arrangement shown, alignment feature 78 is positioned adjacent the free end 74 of flexible arm 70 and extends inwardly therefrom a distance more than teeth 76. Unlike teeth 76 alignment feature does not extend the vertical height of flexible arm 70. Instead, alignment feature 76 is vertically centrally positioned and vertically narrower than teeth 76.

An opening 80 is positioned through the free end 74 of flexible arm 70. This opening 80 connects to a first upper alignment groove 82 positioned in the upper surface of the free end 74 of flexible arm 70 as well as a first lower alignment groove 83. The first upper alignment groove 82 points or guides back in the direction of center of spool 60. The first lower alignment groove 83 points or guides back in the direction of the length of flexible arm 70. A second alignment groove 84 is positioned in the upper surface or alternatively in the body of flexible arm 70 adjacent base 72. The second alignment groove 84 guides in the direction of the radius of socket 60.

An opening 86 is generally centrally positioned within the upper wall 64 of socket 60. A tower 88 surrounds opening 86 and extends above upper wall 64 a distance. Tower 88 has a wider and more robust portion adjacent the upper wall 64 and transitions to a narrower and less robust portion positioned on top of the wider portion at step 90. Opening 86 extends through tower 88 and into the hollow interior of socket 60. The bottom end of opening 86 connects to third alignment groove 92 which extends through the bottom surface of upper wall 64 and point in the direction of the opening 80 in the free end 74 of flexible arm 70.

A spool 94 is sized and shaped to fit within socket 60. Spool 94 has a centrally positioned axel 96 with a pair of opposing flanges 98 one positioned on either end of axel 96. The exterior periphery of spool 94 has a plurality of teeth 100 which are sized and shaped to meshingly, gearingly or matingly receive teeth 76 when spool 94 is positioned within socket 60 and flexible arm 70 is positioned inwardly towards spool 94. When teeth 100 of spool 94 are engaged by teeth 76 of flexible arm 70, spool 94 is prevented from rotating.

An alignment protrusion 102 extends outwardly from the bottom surface of a flange 98. Alignment protrusion 102 is centrally positioned within spool 94. Alignment protrusion 102 has a recess 104 therein which is sized and shaped to receive a drive mechanism which serves to rotate spool 94. In one arrangement, drive mechanism is the end of a conventional screw driver, Allen wrench or other tool; in this arrangement, the alignment feature is a flat-screw-driver-head recess, a Philips head recess, a hex head recess, a star-drive recess, a square-drive recess, or any conventionally shaped recess which serves to receive a conventional drive mechanism. In the arrangement shown, a flat-screw-driver-head recess 104 is shown.

A through hole 106 extends through the center of axel 96 between flanges 98. Through hole 106 has a step 107 at which point it narrows from a wider portion to a narrower portion. In this way, an end of lift cord 18 can extend into through hole 106 from the narrower side, while the wider portion of through hole 106 retains a knot in lift cord 18 against step 107. In this way, lift cord 18 can be fully recessed within through hole 106 without interfering with lift cord 18 wrapping around axel 96 of spool 94. In one arrangement, as is shown, through hole 106 extends perpendicularly through recess 104 with the narrower stepped portion on one side of recess 104. This arrangement allows a user to push lift cord 18 straight through axel 96, tie a knot into it and then pull the knot tight into the stepped portion of through hole 106 where it is held and engaged. By having through hole 106 go straight through the center of axel 96 and recess 104 the fact that the lift cord does not bend or turn improves the speed at which the lift cord 18 can be connected to the spool 94.

Connection arms 108 are connected to the front side 52 and rear side 54 of bottom wall 50. Connection arms 108 are formed of any suitable size shape and design. In one arrangement, as is shown, connection arms 108 are formed to slidably engage the first openings 32 in bottom bar 14. Connection arms 108 extend upwardly and outwardly from the ends 52, 54 of bottom plate 50. Connection arms 108 include a first angled portion 110 which extends mostly upwardly and slightly outwardly. First angled portion 110 then transitions at its upper and outward end to a second angled portion 112 which extends mostly outwardly and slightly upwardly. A first finger 114 extends downward from second angled portion 112 adjacent the middle of second angled portion 112. A second finger 116 extends down from the outward end of second angled portion 112 to form a rounded nose. The combination of the exterior peripheries of first finger 114 and second finger 116 on the second angled portion are sized and shaped to frictionally engage first opening 32 of bottom bar 14 within close tolerances and/or tight frictional engagement. The first angled portion 110 rises above far enough to reach over and around finger 34.

A plurality of support ribs are connected to lift cord adjustment device 22. Support ribs are formed of any suitable size, shape and design and are further positioned in any arrangement on lift cord adjustment device 22. In one arrangement, as is shown, a pair of external support ribs 118 extend upwardly from bottom wall 50 and form an X-shape centered on opening 86. The bottom edge of these external support ribs 118 engage the top surface of bottom wall 50. The inward edges of these external support ribs 118 engage the outward surface of sidewall 62 of socket 60. The upper inward edges of these external support ribs 118 engage the outward surface of the wider portion of tower 88. The outward edges of these external support ribs 118 engage the inward side and upper sides of connection arms 108.

A secondary support rib 120 is positioned approximately in the middle of the lift cord adjustment device 22 and is positioned between the external support ribs 118. The bottom edge of these secondary support ribs 120 engage the top surface of bottom wall 50. The inward edges of these secondary support ribs 120 engage the outward surface of sidewall 62 of socket 60. The outward edges of these secondary support ribs 120 engage the inward side and upper sides of connection arms 108.

This arrangement of external support ribs 118 and secondary support ribs 120 provide structural rigidity and strength to lift cord adjustment device 22 while not increasing cost or manufacturing complexity.

Lift Cord Adjustment Device In Operation:

The architectural covering 10 is assembled by attaching the upper end of shade material 16 to the bottom side of header 12. Next, a stiffener 46 is inserted into the bottom cell 17 of shade material 16. Lift cords 18 are strung from an actuation assembly 20 in header 12, through the bottom of header 12, through shade material 16 and through stiffener opening 122 in stiffener 46.

The loose end of lift cords 18 which extend out of the bottom end of shade material 16 and through stiffener 46 is connected to a lift cord adjustment device 22. Each lift cord 18 extends through tower 88 and into the open interior of socket 60. At this point lift cord 18 turns and is positioned within third alignment groove 92 which directs lift cord 18 towards the free end 74 of flexible arm 70. Lift cord 18 spans the gap between socket 60 and flexible arm 70 and enters the first upper alignment groove 82 which is aligned with the third alignment groove 92. The lift cord 18 then enters the opening 80 and heads downward in the center of the free end 74 of flexible arm 70. Lift cord 18 travels a distance within the opening 80 of the free end 74 of flexible arm 70 exiting the through the first lower alignment groove 83 in the bottom side of flexible arm 70. This first lower alignment groove 83 guides lift cord 18 along the length of flexible arm 70. Lift cord 18 travels a length along the exterior surface of flexible arm 70. Next, the lift cord 18 enters socket 60 through the second alignment groove 84 adjacent base 72 of flexible arm 70. Second alignment groove 84 directs lift cord 18 in an arcuate direction such that it easily wraps around spool 94.

The free end of lift cord 18 is then passed through the through hole 106 in the axel 96 of spool 94. The lift cord 18 passes from the narrower side of through hole 106, past step 107 and into the wider side of through hole 106. A knot is tied into lift cord 18 at an appropriate position. Next the lift cord 18 is pulled tight such that the knot therein is engaged with the step 107 and with the knot residing within the wider portion of through hole 106. In this position, the knot does not interfere with or protrude from axel 96.

Spool 94 is then inserted within socket 60 of lift cord adjustment device 22. Care is taken to ensure the protrusion 102 of spool extends outwardly from the bottom side of lift cord adjustment device 22. In this position, the alignment feature 78 extending inwardly from the free end 74 of the flexible arm 70 is positioned between the flanges 98 of spool 94 thereby helping to hold spool 94 within socket 60 and further helping to provide alignment thereof. Once in this position, the slack is then taken up by rotating spool 94 using a conventional screwdriver inserted within recess 104.

The upper end of the tower 88 is inserted within the stiffener opening 122. This serves at least two purposes. First, insertion of the tower 88 into the stiffener opening 122 helps to maintain alignment of the lift cord adjustment device 22 such that it is always positioned below where the lift cord 18 exits the shade material 16. In addition, because the stiffener 46 is often made of metal and the lift cord adjustment device 22 is often made of a plastic, rubber, synthetic material, UHMW or another composite material which is often injection molded or machined smooth, the tower 88 reduces the potential for the lift cord 18 to be cut by passing through the sharp hole in the stiffener.

The bottom end of the shade material 16 with stiffener 46 therein is inserted within the second opening 36 in bottom bar 14 which holds it in place therein. The lift cord adjustment device 22 is inserted within the bottom bar 14 by aligning the connection arms 108 with the first openings 32 in the bottom bar 14. In this position, the first and second fingers 114, 116 of connection arms 108 fit within and frictionally engage the first openings 32 in bottom bar 14 thereby providing alignment to lift cord adjustment device 22. In this position, the bottom surface of bottom wall 50 is in flush engagement with the bottom wall 26 of bottom bar 14.

The lift cord adjustment device 22 is slid from an end 24 along bottom bar 14 until the protrusion in spool 94 falls in or is forced within the bottom bar opening 124 (not shown). In this position, the tower 88 is positioned within the stiffener opening 122. In this way, alignment is maintained by tower 88 and protrusion 122 fitting bottom bar opening 124 and stiffener opening 122.

In this position, the length of lift cord 18 can be easily adjusted. In addition, a great amount of adjustment is provided. In one arrangement over 12 inches of adjustment is easily provided.

To adjust the length of the lift cord 18 to level out the bottom bar 14 or to adjust the length of the architectural covering 10, the bottom bar is lifted up thereby taking the weight off of lift cord 18. This allows some slack in lift cord 18 which allows the natural spring of flexible arm 70 to spring out from spool 94. That is, when the weight is lifted from bottom bar 14 the teeth 76 on the inside edge of flexible arm 70 disengage the teeth 100 on the outer periphery of flanges 98 of spool 94. This disengagement allows free and easy rotation of spool 94.

Once the bottom bar 14 is lowered again, the tension on the lift cord 18 pulls lift cord upwardly through tower 88. This pulls lift cord 18 passing through the opening 80 in flexible arm 70 toward tower 88 which forces teeth 76, 100 to engage one another thereby preventing rotation of spool 94.

One advantage of this arrangement, is the harder the bottom bar 14 is pulled down, the harder the teeth 76, 100 engage one another. Therefore, the harder lift cord 18 is pulled, the less likely it is that lift cord adjustment device 22 will unintentionally release the lift cord 18.

Another advantage of this arrangement is that the lift cord 18 is pulled straight up through tower 88 which eliminates any rotational torque on the system. When the lift cord 18 is pulled upward, the lift cord adjustment device 22 tends to slightly bend upward. While the structural rigidity of the lift cord adjustment device 22 resists this bending, it is somewhat unavoidable. To ensure that the alignment protrusion 102 does not come out of the bottom bar opening 124, as the lift cord is pulled upward, and the lift cord adjustment device 22 bends upward, the prongs 66 bend downward. This opposite action has the effect of maintaining the alignment protrusion 102 in the bottom bar opening 124. The more the lift cord adjustment device 22 bends upward, the more the prongs 66 bend downward and the more the protrusions 68 force spool 94 downward which maintains alignment protrusion 102 within bottom bar opening 124.

Alternative Arrangement of Lift Cord Adjustment Device for Venetian Shades:

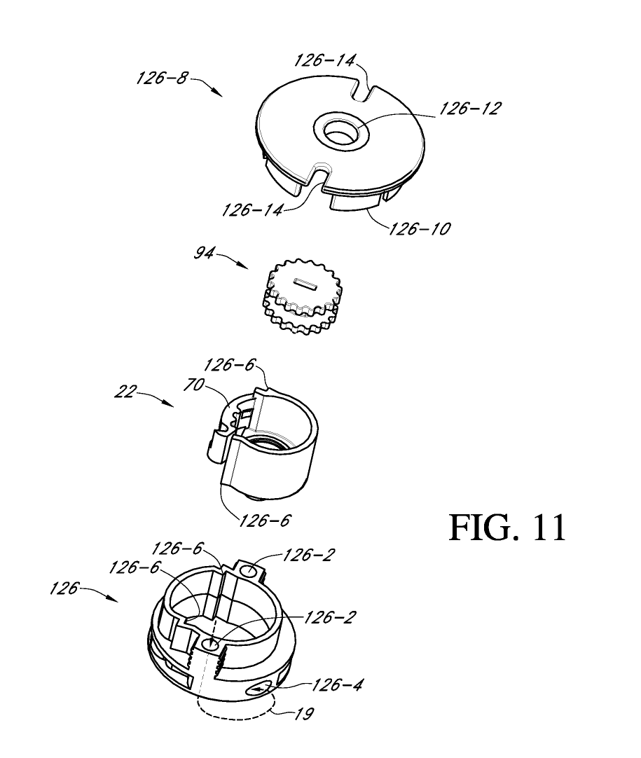

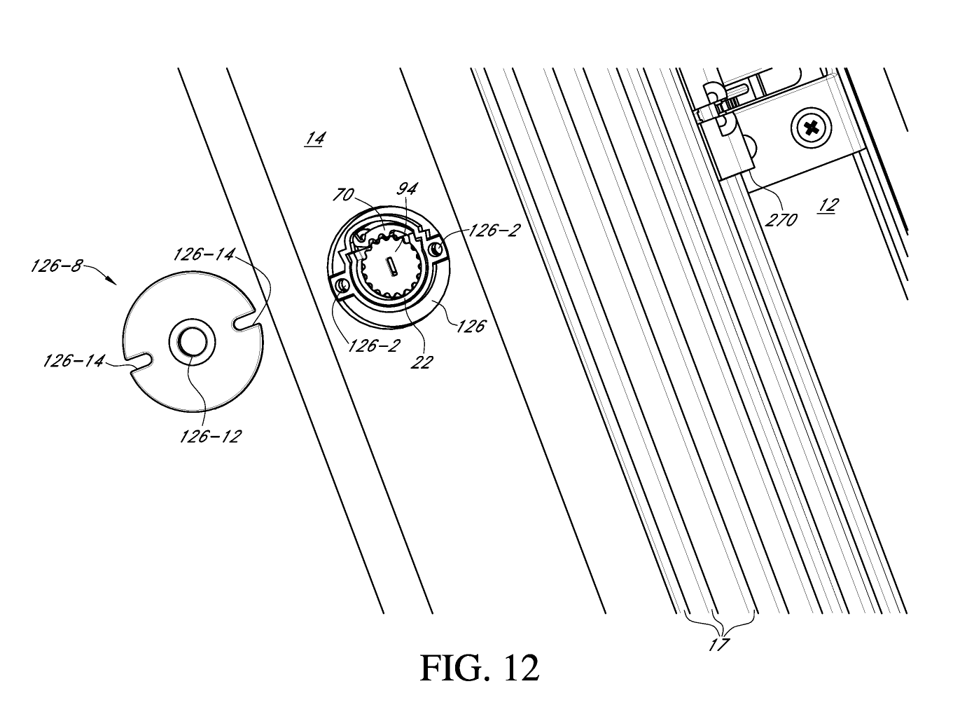

With respect to FIGS. 11 and 12, an alternative arrangement is provided for lift cord adjustment device 22 for use specifically with Venetian shades. Venetian shades not only include lift cords 18, but also include tilt cords or ladders 19 that must be addressed. Unless stated otherwise, the lift cord adjustment device 22 presented in FIGS. 11 and 12 includes the salient features presented above as it adjusts the length of lift cords 18 as well as providing an attachment means for the ends of tilt cords 18 among the other improvements and additions described herein.

As one example, in the arrangement presented the lift cord adjustment device 22 includes collar 126. Collar 126 is generally cylindrical in shape and is sized and shaped to be inserted in an opening in the bottom of bottom bar 14. Collar 126 includes a pair of vertical openings 126-2 that extend generally vertically through collar 126, and a pair of horizontal openings 126-4 the extend generally horizontally through a portion of collar 126. When collar 126 is inserted in bottom bar 14, horizontal openings 126-4 are positioned at or near the upper end of collar 126. The pairs of vertical openings 126-2 and horizontal openings 126-4 are positioned on approximately opposite sides of the lift cord adjustment device 22.

The open interior of collar 126 includes at least one, and as is shown an opposing pair of alignment features 126-6, such as grooves or protrusions. These alignment features 126-6 extend vertically the height of collar 126. In this arrangement, lift cord adjustment device 122 includes similar, identical or opposite alignment features 126-6 in its exterior cylindrical surface. In this way, lift cord adjustment device 22 fits within the interior opening of collar 126 with close tolerances with the alignment features 126-6 aligning with the alignment features 126-6 of the lift cord adjustment device 22. In this way, alignment of the two components is maintained and rotation is prevented while lift cord adjustment device 22 is allowed to vertically slide within collar 126.

A cap 126-8 is also presented. Cap 126-8 fits over the lift cord adjustment device 22 and collar 126 when inserted in bottom bar 14. Cap 126-8 is sized and shaped to frictionally hold onto and engage collar 126 and/or the opening collar 126 fits within in bottom bar 14 with close and tight frictional tolerances thereby preventing unintentional removal. In the arrangement shown, cap 126-8 includes a flange 126-10 that extends upward from the main body of cap 126-8 and reaches towards and engages collar 126. Cap 126-8 also includes generally centrally positioned opening 126-12 that provides access to spool 94 positioned within lift cord adjustment device 22 for adjustment purposes. Cap 126-8 also includes a pair of recesses 126-14, positioned opposite from one another, that allow for passage of tilt cord 22 around bottom bar 14 and into collar 126. The presence of cap 126-8 over lift cord adjustment device 22 provides an improved aesthetic appearance that is more refined.

In operation, loose ends of tilt cord 19 reach around opposite sides of bottom bar 14. Each end of tilt cord 19 extends upwardly into vertical openings 126-2 and out of the upper edge of collar 126. Next, the loose ends of tilt cord 19 are inserted into the horizontal openings 126-4 and the collar 126 is inserted into the opening in the bottom bar 14. In this way, the ends of tilt cord 19 are cinched in place both by being pinched between the upper edge of the collar 126 and the opening in the bottom bar 14, as well as the sharp turn that the tilt cord 19 must take to transition from the vertical openings 126-2 to the horizontal openings 126-4. Because the lift cord 18 extends through an opening in the bottom bar 14, and into collar 126, the lift cord 18 actually helps to hold the lift cord adjustment device 22 into the bottom bar 14 and collar 126. In addition, as is described herein, the flexible arm 70 uses the weight of the bottom bar 14 to lock the length of lift cord 18 in place within spool 94. As such, an improved lift cord adjustment device 22 is presented.

Header Assembly:

Header 12 is formed of any suitable size, shape and design. In one arrangement header 12 is formed of a single solid piece of extruded or formed material that is suitably durable and rigid but light weight as well, such as aluminum, alloy, composite, plastic, nylon, fiberglass or the like. In the arrangement shown, when viewed from the side, header 12 has a bottom wall 130 connected at its rear edge to a back wall 132 which connects at its upper edge to the back edge to top wall 134. The plane of bottom wall 130 and top wall 134 extend in generally parallel spaced relation to one another, whereas the plane of back wall 132 extends in generally perpendicular alignment to the plane of bottom wall 130 and top wall 134. In this way, bottom wall 130, back wall 132 and top wall 134 define a hollow interior space within header 12 wherein the other components of the system reside as is described herein. The front side of header 12 is open, this allows for access to the components positioned within the header 12, it allows for easy access of remote control signals to the components of the header 12 and it allows for a decorative fascia 136 to be connected over the header 12.

Header 12 also includes a plurality of features that provide additional strength and rigidity to header 12 as well as provide features to which other features are mounted thereto. A bottom alignment feature 138 is positioned in the bottom wall 130 and a back alignment feature 140 is positioned in the back wall 132. This bottom alignment feature 138 and back alignment feature 140 are formed of any suitable size, shape and design. In the arrangement shown, bottom alignment feature 138 and back alignment feature 140 are simply square or rectangular protrusions or recesses that protrude into or recess from the open interior of header 12 thereby breaking the flat plane of the bottom wall 130 and back wall 132 so as to provide alignment and guidance to other components positioned within header 12.

A lip 142 extends upwardly from the forward end of bottom wall 130 a short distance. Lip 142 terminates in a groove or channel 144 positioned at its end which is used to connect components thereto as is described herein.

A rear lip 146 extends slightly outwardly and downward from the rears side of back wall 132 thereby defining a channel or groove between back wall 132 and rear lip 146. A structural feature 148 extends outwardly from the back wall 132 adjacent its middle and its upper end, as does one out of the top wall 134 adjacent its rear edge. These structural features 148 can be formed of any suitable size, shape or design, and in the arrangement shown are generally rectangular in shape.

Top wall 134 also includes a number of features. A groove 150 is positioned in the inside surface of top wall 134 adjacent its middle. A lip 152 extends forward from the top side of the material that forms groove 150 thereby defining a groove or channel between the top surface of top wall 134 and lip 152. The forward most edge of top wall 134 terminates in an upwardly extending lip 154 and a channel 156 extends upwardly from the top surface of top wall 134 just rear of lip 154. In the arrangement shown, channel 156 is in the shape of a T-channel, which houses a light seal 158, such as a piece of conventional woolpile, which is used to block light between the top edge of housing 12 and the window frame system 10 is mounted in.

A fascia mounting bracket 160 is connected to the front edge of bottom wall 130 and top wall 134. Fascia mounting bracket 160 has a generally flat and planar face 162 that is slightly recessed with respect to feet 164 positioned at its bottom and top edges. Feet 164 extend forward from face 162 a distance and arcuately curve rearward to form a channel that is sized and shaped to fit over receive the lips positioned at the forward most ends of bottom wall 130 and top wall 134. In this way, feet 164 hold fascia mounting bracket 160 onto header 12 in firm frictional engagement. Fascia mounting bracket 160 is, in one arrangement formed of a metallic material such that magnets can be magnetically attached thereto. Alternatively, fascia mounting bracket 160 is formed of any other material and magnets or metallic material are connected thereto or placed therein so as to allow for magnetic attachment of other components.

A magnet plate 166 is formed of a generally planar piece of material having a plurality of recesses 168 positioned in vertical alignment with one another across the middle of magnet plate 166. A magnet 170 is positioned in one or all of these recesses 168. In the arrangement shown, recesses 168 and magnets 170 are disk or round in shape, however any other shape is hereby contemplated. A plurality of mounting holes 172 are positioned along the edges of magnet plate 166 and are used to pass conventional fasteners, such as screws or bolts, into decorative fascia 136.

Decorative fascia 136 is any decorative piece that closes the open interior of header 12. In the arrangement shown, decorative fascia 136 is a conventional piece of decorative trim that is formed of wood, plastic or the like material. Magnet plate 166 is connected to the interior surface of decorative fascia 136 by conventional fasteners adjacent each end of decorative fascia 136, or at any other location. Fascia mounting brackets 160 are slid over the ends of header 12 and positioned at the same approximate relative position on header 12 where magnet plates 166 are connected to decorative fascia 136.

Once the magnet plates 166 are connected to decorative fascia 136 and fascia mounting plates 160 are slid over header 12 into the approximate corresponding position, attaching the decorative fascia 136 is as easy and simple as placing the fascia 136 over the header 12 until the magnets 170 attached to fascia 136 attract to the metal of fascia mounting brackets 160. Improved alignment and improved strength of attraction and hold is provided when corresponding magnets are placed on or as part of the fascia mounting brackets 160 as well as part of magnet plate 166. However, in this arrangement, care should be applied to ensure that the magnetic poles of the magnets 170 of the magnet plate 166 are aligned with the poles of the magnets 170 of the fascia mounting bracket 160. Hold provided by attaching magnets 170 to both magnet plates 166 and fascia mounting brackets 160 is many times stronger than merely magnetically attaching to a piece of metal, and precise automatic alignment is also provided because the opposing magnets 170 magnet plates 166 and fascia mounting brackets 160 seek to center themselves with respect to one another.

In the arrangement shown, the flat planar face 162 of fascia mounting bracket 160 is recessed from the forward most edge of feet 164 approximately the depth of magnet plate 166. In this way, when fascia 136 is attached to fascia mounting brackets 160 the rear face of fascia 136 is flush with the forward most edges of header 12. As such, fascia 136 can be quickly added and quickly removed with little fuss and no tools.

Drive Shaft Assembly:

A drive shaft assembly 174 is positioned within the header 12. Drive shaft assembly 174 is formed of any suitable size, shape and design. In the arrangement shown, drive shaft assembly 174 includes a drive shaft 176 that extends a length within the header 12. A plurality of lift and tilt cord assemblies 178 are positioned along the length of drive shaft 176 and are aligned with where each lift cord 18 and tilt cord 19 enter header 12.

Lift and tilt cord assemblies 178 include a housing 180 that has a generally rectangular or square shape when viewed from the side with a square rearward upper edge and a square forward lower edge. Housing 180 is sized and shaped to frictionally fit within and between the interior surface of bottom alignment feature 138 and the bottom surface of back alignment feature 140. In this arrangement, housing 180 is slidable along the length of header 12, however, locked between bottom alignment feature 138 and the bottom surface of back alignment feature 140, which prevents forward to back or up and down movement.

Housing 180 has opening in its middle which receives a lift cord assembly 182. Lift cord assembly 182 includes a holder 184 with a lift spool 186 rotatably positioned therein. The upper end of lift cord 18 connects to and wraps around lift spool 186 so as to raise and lower shade material 16. A hollow nipple 188 extends downward from holder 184 and through an opening in housing 180 as well as an opening in the bottom wall 130 of header 12. The extension of nipple 188 through housing 180 and header 12 maintains the lateral alignment of lift and tilt cord assembly 178 within header 12. Lift cord 18 extends through the hollow interior of nipple 188, and in this way, nipple 188 also prevents lift cord 18 from getting abraded by the potentially sharp edges of the openings in housing 180 and header 12 that lift cord 18 extends through. The bottom end of nipple 188 terminates adjacent to or flush with the bottom surface of header 12, and is positioned approximately at the middle of shade material 16 and approximately equally spaced between the forward and rearward lines of the tilt ladder 19.

Holder 184 has an opening in its ends which allows drive shaft 176 to extend there through thereby defining an axis of rotation. Aligned with this opening is an opening in lift spool 186. The opening in lift spool 186 is sized and shaped to receive the square, irregular or non-round shape of drive shaft 176 within close tolerances. In this way, rotation of drive shaft rotates lift spool 186, thereby raising and lowering the shade material 16.

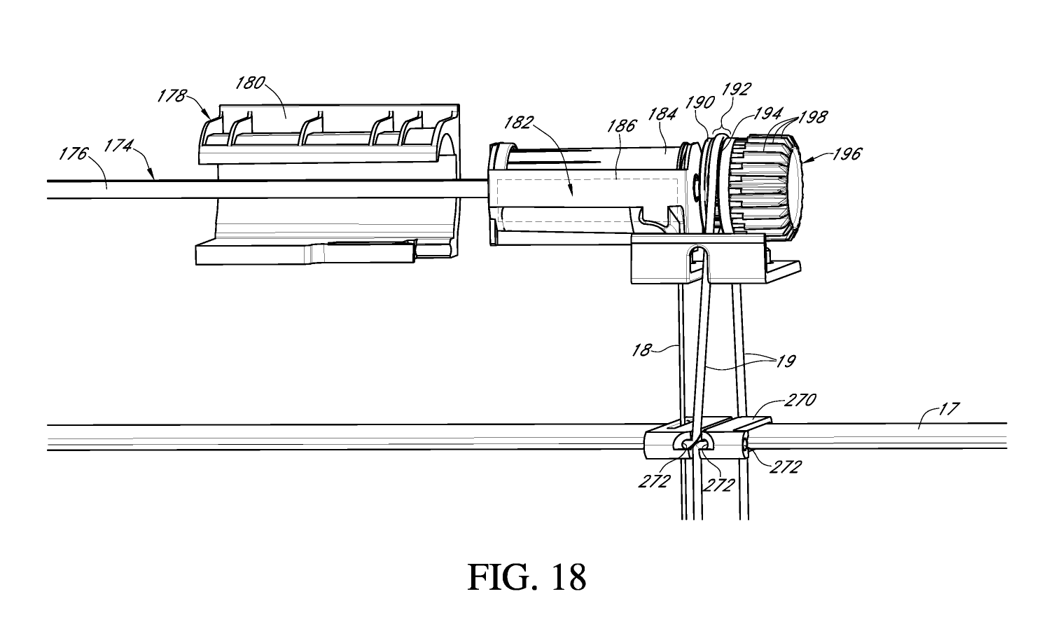

A tilt spool 190 is also connected to drive shaft 176. Tilt spool 190 is positioned adjacent the end of holder 184 where nipple 188 extends outwardly from. Tilt spool 190 is any form of a spool. In the arrangement shown, tilt spool 190 has an opening at its middle that is sized and shaped to receive the square, irregular or non-round shape of drive shaft 176 within close tolerances just like lift spool 186, and is aligned with lift spool 186 on the same axis of rotation. Tilt spool 190 has a groove 192 positioned therein which receives and retains the top end of tilt ladder 19. To increase the friction and grip between tilt ladder 19 and groove 192 the surface of groove is abraded, roughened or has features therein to help grab tilt ladder 19 so as to ensure proper tilting thereof. In addition, in another arrangement, one compressible member 194, such as a layer of plastic or rubber, or one or more O-rings are is positioned within groove 192 to increase the friction between the groove 192 and the top end of the tilt ladder 19. In the arrangement shown in FIG. 18, the top loop of tilt cord 19 is raised to show the tilt spool 190, in this figure a pair of O-rings 194 are positioned next to one another in frictional engagement with one another filling groove 192 of tilt spool, thereby providing improved friction and therefore improved tilt. In one arrangement, O-rings formed of Polyurethane having an A90 Durometer have been tested with success, providing excellent wear resistance and a proper amount of friction. Because tilt spool 190 is connected to drive shaft 176 on the same axis of rotation as the lift spool 186, tilt spool 190 and lift spool 186 rotate simultaneously and in unison as the drive shaft 176 is rotated. Tilt spool 190 is positioned just above where tilt ladder 19 (as well as lift cord 18) enters header 12.

Positioned adjacent one end of the drive shaft 176 is a drive adapter 196. Drive adapter 196 is formed of any device which is used to connect drive shaft 176 to another device to motorizably rotate drive shaft 176. In the arrangement shown, drive adapter 196 is generally circular or tubular in shape and includes a plurality of teeth 198 in its exterior, or alternatively interior, surface. To save or eliminate an additional part, drive adapter 196 doubles as a tilt spool 190 as the end of drive adapter 196 connected to drive shaft 176, or opposite teeth 198, includes a groove 192 and receives the top end of a tilt ladder 19 as well as compressible members 194, as is shown in FIG. 18.

In the arrangement shown, tilt spool 190, whether it is separate or a part of drive adapter196 resides under a portion of housing 180 so as to help retain tilt ladder within groove 192. Said another way, the groove 192 of tilt spool 190 is positioned under a shroud or over hanging portion of housing 180 so that the top end of tilt ladder 19 is trapped within groove 192 and cannot unintentionally escape therefrom. This is especially useful in shipping and installation of the shade 10 as weight is often not on the tilt cord 19 and without the shrouding of housing 180 the tilt cord 19 has the potential to escape groove 192.

Modular Spring Housing:

The system 10 also includes a plurality of modular spring housings 200. Modular spring housings 200 are formed of any suitable size, shape and design. In the arrangement shown, spring housings 200 are formed of a first housing 202 that connects along a seam line to a second housing 204 thereby defining an open interior space. In the arrangement shown, the two housings 202, 204 are held together by a pair of snap-fit features 205A in one housing 202, 204 that are received in openings 205B of the housings 202, 204. In addition, these snap fit features 205A are aligned by alignment features in the two housings 202, 204 such as the mating rail and groove arrangement shown. Also, the exterior surface of housings 202, 204 include structural features 205C, such as corrugation or flanges

Positioned within this open interior space is a storage spool 206 and an output spool 208 which are held separate from one another within spring housing 200 by internal features of spring housing 200. Storage spool 206 and output spool 208 are allowed to freely rotate within their respective cavities within spring housing 200.

In the arrangement shown, storage spool 206 and output spool 208 are vertically stacked with one another so as to reduce the depth of header 12. Output spool 208 includes an opening at its middle that is sized and shaped to receive the square, irregular or non-round shape of drive shaft 176 within close tolerances just like lift spool 186, and tilt spool 190 and is aligned on the same axis of rotation and rotates with drive shaft 176. A spring 210, which takes the form of a ribbon of spring steel, and is known as a ribbon spring, a power spring, a clock spring or the like is stored on storage spool 206 in a static state, and is loaded onto output spool 208 as drive shaft 176 is rotated. Spring 210 may be a “positive gradient spring,” meaning its force imparted on output spool 208 increases as more spring is loaded onto output spool 208, a “constant gradient spring,” meaning constant force is imparted on output spool 208 as the spring is loaded onto output spool 208, a “negative gradient spring,” meaning its force imparted on output spool 208 decreases as more spring is loaded onto output spool 208, or a “variable gradient spring,” meaning its force imparted on output spool 208 varies as more spring is loaded onto output spool 208. Spring 210 can be standard wound around the storage spool 206 and the output spool 208, or reverse wound around the storage spool 206 and the output spool 208. To assist with assembly, the output spool 208 is labeled with indicia that helps to identify whether the spring 210 is standard wound or reverse wound. As one example, the output spool 208 is marked with an “S” on one side of the output spool 208 and an “R” on the opposite side of the output spool 208. These markings quickly identify whether the spring is reverse wound, when it is wound in the direction indicated by the “R;” or standard wound, when it is wound in the direction indicated by the “S”.

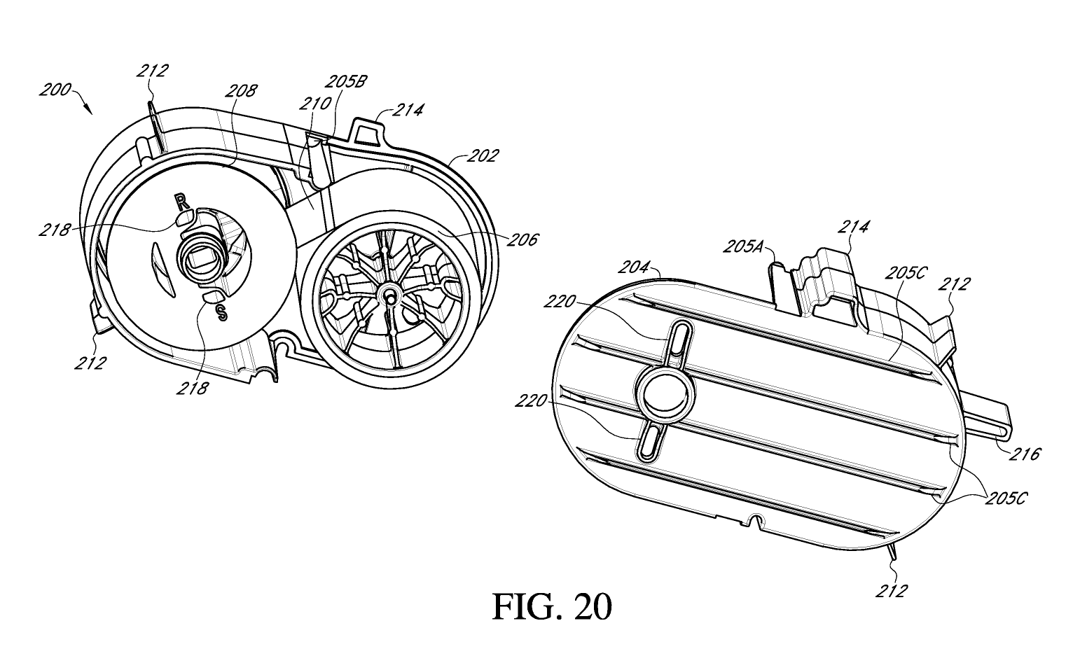

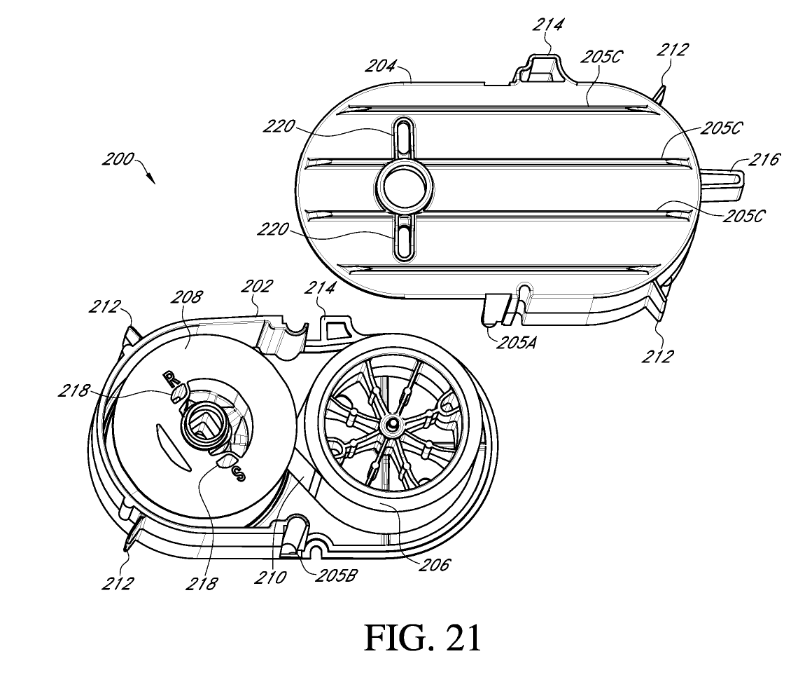

As an example, a standard wound spring 210 is presented in FIG. 20, and a reverse wound spring 210 is presented in FIG. 21. A standard wound spring 210 means that when the shade 10 is at a fully opened position, a small portion of the spring 210, somewhere between a portion of a wind and a couple of winds, is positioned around the output spool 208 whereas a majority of the spring 210 is around the storage spool 206. As the shade 10 is moved from an open position to a closed position, the spring 210 is loaded from the storage spool 206 onto the output spool 208 thereby transferring the torque generated to the driveshaft 176 extending through the output spool 208. In the figure shown in FIG. 20, the majority of the spring 210 is positioned around the storage spool 206.

A reverse wound spring 210 means that when the shade 10 is at a fully opened position, a small portion of the spring 210, somewhere between a portion of a wind and a couple of winds, is positioned around the storage spool 206 whereas a majority of the spring 210 is around the output spool 208. As the shade 10 is moved from an open position to a closed position, the spring 210 is loaded from the output spool 208 onto the storage spool 206 thereby transferring the torque generated to the driveshaft 176 extending through the output spool 208. In the figure shown in FIG. 21, the majority of the spring 210 is positioned around the storage spool 206.

A reverse wound spring and a reverse wound spring housing 200 is converted to a standard wound spring and a standard wound spring housing 200 by merely rotating the spring housing 200 on drive shaft 176 by 180 degrees. As such, care must be taken to ensure that orientation of the spring housing 200 when inserted into header 12 is correct. To ensure proper alignment (and prevent the spring housings 200 from being installed backwards or reverse) alignment features are positioned in the spring housing 200 that only allow the spring housing 200 to be inserted in one orientation.

That is, the exterior surface of spring housing 200 includes a plurality of alignment features that align with features in header 12. In the arrangement shown, the bottom surface of spring housing 200 engages the top surface of the bottom wall 130 of header 12. In addition, a plurality of alignment features 212 extend outwardly from the spring housing 200 and receives or engages the open interior surface of header 12.

A back alignment feature 214 is positioned adjacent the back of spring housing 200 and receives or engages the structural feature 148 in the back wall 132 of header 12. In the arrangement shown, back alignment feature 214 is a protrusion, which is positioned vertically off-center in spring housing 200 to ensure that the spring housing 200 can only be installed in the proper orientation, that is received within the groove of the structural feature 148 in the back wall 132.

A top alignment feature 216 is positioned adjacent the top of spring housing 200 and receives or engages the groove 150 in the top wall 134 of header 12. Top alignment feature 216 is off-center with respect to the front-to-back depth of spring housing 200 so as to ensure that spring housing 200 can only be installed in the proper orientation when top alignment feature 216 is received within groove 150. This engagement of top alignment feature 216 in groove 150 prevents the top end of spring housing 200 from wobbling, moving or rotating as drive shaft 176 rotates.

These alignment features 212, 214 216 of spring housing 200 and their engagement with the alignment features 138, 140, 150 of the header 12 allow for spring housing 200 to be slid into and along the length of header 12, however prevent movement in all other directions.

As many spring housings 200 as are needed can be inserted along any portion of drive shaft 176. Because the spring housings 200 are individual, or modular in nature, they can be inserted at the ends of the drive shaft 176 and/or positioned between the lift and tilt cord assemblies 178. Any type of spring or spring combination can be used by using a plurality of spring housings 200. In this way, spring housings 200 are “modular” as any number or combination can be quickly and easily applied to the system 10.

To allow the springs 210 to be pre-wound or pre-loaded, output spools 208 include a pair of winding openings 218 positioned adjacent to the opening that receives drive shaft 174. These winding openings 218 are aligned with similar winding openings 220 in housing 200. In this arrangement, a spring 210 is pre-wound by rotating a drive-shaft 176 inserted into the drive shaft opening and loading a portion of spring 210 onto the output spool 208. Once the desired amount of spring 210 is loaded onto the output spool 208, the winding openings 218 of output spool 208 are aligned with the winding openings 220 of the housing 200 and a locking pin is inserted thereby locking output spool 208 in place with the preload thereon. This allows the drive shaft 176 to be removed. When the pre-wound housing 200 is installed into shade 10, this locking pin is simply removed once the drive shaft 176 is inserted far enough to prevent unwinding of the spring 210.

Motor Controller Assembly:

The system 10 includes a motor controller assembly 230. Motor controller assembly 230 is formed of any size, shape and design. As one example, in the arrangement shown, motor controller assembly 230 includes a motor housing 232 which defines a hollow interior with a motor 234 and motor controller 236 positioned therein and covered by a removable cover plate 238.

Motor 234 is any motor, such as a DC motor which converts electrical energy to mechanical energy. Motor 234 is connected to a motor controller 236. Motor controller 236 is any device which controls the operation of motor 234. In one arrangement, motor controller 236 is an electrical circuit board or printed circuit board which is electrically connected to a microprocessor 240, to memory 242, a receiver or transceiver 244 and an antenna 246. Microprocessor 240 is any programmable device that accepts analog or digital signals or data as input, processes it according to instructions stored in its memory 242, and provides results as output. Microprocessor 240 receives signals from receiver or transceiver 244 and processes them according to its instructions stored in its memory 242 and then controls motor 234 based on these signals. Memory 242 is any form of electronic memory such as a hard drive, flash, ram or the like. Antenna 246 is any electronic device which converts electric power into electromagnetic signals or electromagnetic waves, which are commonly known as radio waves or RF (radio frequency) (hereinafter collectively referred to as “electromagnetic signals” without limitation). Antenna 246 can transmit and/or receive these electromagnetic signals. In one arrangement these electromagnetic signals are transmitted via AM or FM RF communication, while any other range of RF is hereby contemplated. In the arrangement shown, a monopole antenna 246 is shown that extends outwardly from the motor housing 232 and is taped to the external surface of motor housing 232 for purposes of strong reception, however any other form of an antenna is hereby contemplated such as a fractal antenna, a telescoping antenna, or the like.

Motor controller 236 is also connected to a power source 248 such as batteries, hard wired power, or the like. In the arrangement shown a plurality of batteries 250 are held within a battery compartment 252 which, in one arrangement, is formed as a single unitary part with motor housing 232 (therefore, reference to motor housing 232 shall serve simultaneously as reference to battery compartment 252—however it is hereby contemplated that the battery compartment 252 in other arrangements is separate and standalone from motor housing 232). In the arrangement shown, battery compartment 252 is generally tubular in shape, thereby mimicking the shape of conventional AAA, AA, C and D sized batteries and further has an open front face so as to provide access to the batteries 250 for installation and replacement. When in place within battery compartment 242 batteries 250 are stacked in end-to-end alignment with one another. Battery compartment 252 includes a plurality of flexible tabs 254 positioned at approximately the middle of each battery 250. These flexible tabs 254 include an upwardly and/or inwardly extending protrusion at their ends that help to hold batteries 250 within the open interior of battery compartment 252 without allowing them to unintentionally escape. However, the flexible tabs 254 can be deflected to allow removal or reinstallation of batteries 250. In the arrangement shown, battery compartment 252 is vertically stacked with motor 234 thereby reducing the depth of header 12.

Motor 234 includes a motor shaft 256 connected to a motor gear 258. Motor gear 256 is formed of any size, shape and design. As one example, in the arrangement shown, motor gear 258 is a female gear with internal gear teeth 260 which is sized and shaped to operably engage and receive drive adapter 196 connected to the end of drive shaft 176. However, the opposite can be true, meaning that the drive adapter 196 can be female while the motor gear 258 can be male. In either arrangement, the system can be transformed from a manual shade system to a motorized gear system by merely sliding the motor controller assembly 230 into an open end of header 12 such that the teeth 198 of drive adapter 196 engage the teeth 260 of the motor gear 258. Once installed, when the motor 234 rotates, this rotation is transferred to motor gear 258 which is transferred to drive adaptor which rotates the drive shaft 176 which raises or lowers the shade material 16 while also tilting the shade material 16.

To provide alignment with drive shaft 176, motor housing 232 is sized and shaped to fit within close tolerances within the open interior of housing 12. More specifically, the bottom forward edge of motor housing 232 engages the bottom alignment feature 138 such that the motor housing 232 fits behind this bottom alignment feature 138. In the arrangement shown, when the motor housing 232 is inserted in the header 12 the bottom surface of motor housing 232 fits flushly with the upper surface of the bottom wall 130 of header 12, and fits just rear of the bottom alignment feature 138, and the top of the motor housing 232 engages the bottom surface of the top wall 134, and the back of the motor housing 232 fits flushly with forward surface of back wall 132. In this arrangement, movement of the motor housing 232 is limited to laterally sliding along a length of the header 12. In this way, the motor controller assembly 230 can be added and removed to header 12 by laterally insertion and removal to convert the system 10 between a manual and a motorized shade system.

To improve the connection between header 12 and motor housing 232, motor housing 232 may include alignment features, such as recesses or protrusions that mate with similar alignment features in header 12, such as recesses or protrusions. In the arrangement shown, an alignment protrusion 261 is positioned at the left most upper edge of motor housing 232 and right most upper edge of motor housing 232. These alignment protrusions 261 engage the groove 150 in the interior surface of top wall 134. This engagement locks the upper edge of motor housing 232 in place and prevents rotation of motor housing 232 as drive shaft 176 rotates.

Motor Control:

Motor 234 includes a secondary motor shaft 262 which extends outwardly from the opposing side of motor 234 from motor shaft 256. Secondary motor shaft 262 rotates simultaneously with motor shaft 256. A magnetic wheel 264 is connected to secondary motor shaft 262 and rotates with secondary motor shaft 262. Secondary motor shaft 262 also extends through a portion of the printed circuit board of motor controller 236 which is fastened by conventional fasteners, such as screws, to the end of motor 234. Positioned on this printed circuit board, adjacent or within sensing distance of magnetic wheel 264 is one or more sensors 266. In one arrangement, as is shown, sensors 266 are a pair of Hall Effect Sensors, however any other type of sensor is hereby contemplated for use. When powered up, as the magnetic wheel 264 rotates the Hall Effect sensors sense the passing of the magnetic fields generated by the magnetic wheel 264 and these signals are transmitted to microprocessor 240. This information is used to calculate the vertical position of the shade material 16 as well as the tilt of slats 17.

As an example, as the shade 10 moves between a fully raised and a fully lowered position the microprocessor counts the signals or ticks sensed by the sensors 266. This number of signals or ticks or rotations of the motor 234 is the total number of signals or ticks or rotations required to fully open or close the shade 10. Therefore, if the shade 10 is commanded by a remote control 268 to move to a half-open or 50% position, the microprocessor 240 knows it only needs to move half that number of signals or ticks or rotations from either the fully raised or fully lowered position. The same calculation occurs for any position, such as 25% open or 33% open or 75% open, or any other position. The current position of the shade is stored in the memory 242 of the motor controller 236 so that when the next command is received the shade 10 moves directly to that position.

To ensure that the shade 10 does not get lost, or lose accuracy of its position, microprocessor 240 is programmed to, from time-to-time or every predetermined number of commands, or randomly, perform a hard stop, where the shade is fully opened by the motor 234 until the motor 234 stalls or physically stops. At which point the counter of the microprocessor 240 resets and the accuracy of the position is confirmed.

Because the tilt spools 190 and the lift spools 186 simultaneously rotate as motor 234 rotate, when the motor 234 initially rotates, the slats 17 of the shade material 16 initially tilt in the direction of the movement. That is, if the shade is raised, the slats 17 initially tilt up, or if the shade is lowered, the slats initially tilt down. This tilting occurs until the slats 17 are fully tilted, at which point the tilt spool 190 overcomes the friction between the top of the ladder 19 and begins to freely rotate within the top loop of the ladder 19 and the lift spool 186 continues to rotate, either raising or lowering the shade material 16.

If the motor 234 were simply to stop after reaching its desired vertical position, the slats 17 would be left in a fully tilted up or fully tilted down position, depending on the direction of the last move. To improve the aesthetics of the system 10, after the shade material 16 is raised or lowered to the desired position, the motor controller 236 commands the motor 234 to rotate a distance, or number of rotations in the opposite direction. This opposite rotation allows the tilt spool 190 again to use its friction with the top loop of the tilt ladder 19 to again tilt the slats 17, this time in the opposite direction. In this way, the motor controller 236 returns the slats to a level or flat position after a raising or lowering of the shade material 16.

That is, just as the motor controller 236 tracks the vertical position of the shade material 16, the motor controller 236 tracks the tilt of the slats 17. The microprocessor 240 is programmed, based on the size of the slats 17, the tilt spool 190, the magnetic wheel 264, and other features of the system 10 to know the number of signals or ticks or rotations it takes to tilt the slats 17 fully up and fully down. From this information, the microprocessor 240 predetermines how to move the slats 17 to the desired position.

As an example, if it takes 200 signals or ticks or rotations to move from a fully tilted up position to a fully tilted down position, or vice versa, the microprocessor 240 calculates that it only takes 100 signals or ticks or rotations in the opposite direction to move the slats 17 to a level position after any movement that is greater than 200 signals or ticks or rotations.

As another example, if it takes 200 signals or ticks or rotations to move from a fully tilted up position to a fully tilted down position, the microprocessor 240 calculates that it only takes 50 signals or ticks or rotations to move the slats 17 to a half tilted position from a level position, and so on.

In this way, the sensors 266, magnetic wheel 264 and microprocessor 240 work together to accurately and efficiently position the angle of the slats 17 of the shade material 16 with a simple movement of motor 234.

Bottom Reference Position:

In one arrangement, to improve the accuracy, repeatability and reproducibility of controlling the angular tilt of the slats 17, the microprocessor 240 is programmed to finish each vertical move of the slats 17 by bottoming out the angular tilt of the slats 17. Said another way, each vertical move of the slats ends by moving the bottom bar 14 downward a predetermined distance, wherein the predetermined distance is greater than the distance required to fully tilt the slats 17. This way, the microprocessor 240 accurately has a known reference point from which it can accurately tilt the slats 17.

In one arrangement, when the last move is a downward move of the bottom bar 14, the microprocessor 240 is programmed to recognize that the slats 17 are fully tilted downward, in the reference position and therefore the slats 17 can be accurately tilted by merely rotating the drive shaft 176 in the opposite direction. Because the slats 17 are both raised and tilted by rotating the drive shaft 176, the microprocessor 240 is programmed to take into account the amount of vertical movement caused by tilting the slats 17 to the desired position. As such, when the last move is a downward move, the microprocessor 240 is programmed to drive past the desired bottom bar position by the vertical distance consumed by tilting the slats 17 to the desired angular tilt. In this way, both the desired vertical position of the bottom bar 14 and the angular tilt of the slats 17 is accomplished.

In one arrangement, when the last move is an upward move of the bottom bar 14, the microprocessor 240 is programmed to drive beyond the desired vertical position of the bottom bar 14 by a predetermined amount, then reverse direction and move the bottom bar 14 down a predetermined amount to bottom out the angular tilt of the slats and then move the bottom bar 14 up to the desired angular tilt of the slats. Finishing an upward move of the bottom bar with a downward move, of a predetermined amount that is greater than the distance required to fully tilt the slats 17 in the direction of travel, allows the microprocessor to always start tilting the slats 17 from a known reference point, or a fully tilted down position.

Employing this process provides improved accuracy of tilt by ensuring the slats 17 begin from a known position before they are tilted.

Tug Circuit & Tugging:

To ensure optimal battery life, the motor controller turns the power on and off to the sensors 266. That is, the shade 10 has an awake state wherein the sensors 266 are powered up and sense the rotation of the magnetic wheel 264, and an asleep state where the sensors 266 are turned off. This awake state saves power as sensors 266 tend to draw continuous power. The shade can be converted from an asleep state to an awake state by a manual tug on the shade or by receiving a command signal from remote control 268. This arrangement is more fully described in Applicant's related U.S. patent application Ser. No. 14/251,427 entitled Low-Power Architectural Covering filed on Apr. 11, 2014, which is fully incorporated by reference herein, including any related patents or patent applications.

When a user tugs on the bottom bar 14 the additional weight causes the lift cords to unwind from the lift spools 186 this causes the drive shaft 176 to rotate in the same direction. Because motor 234 is connected to drive shaft 176 through connection of drive adapter 196 and motor gear 258 this causes motor shafts 256, 262 and the magnetic wheel 264 to rotate. This manual rotation of motor 234 creates a current or power surge which is detected by microprocessor 240. When a manual tug is sensed, microprocessor 240 turns on sensors 266 which senses the rotation of magnetic wheel 264 and therefrom tracks the position of the bottom bar 14.

In response to this manual movement of bottom bar 14, the microprocessor 240 is programmed to respond at least one of three ways: (1) the microprocessor 240 moves the bottom bar 14 to the next predetermined stop; (2) the microprocessor 240 moves the bottom bar 14 to a fully opened position (or alternatively to a fully closed position); (3) the microprocessor 240 does not move the bottom bar 14 and instead allows the bottom bar 14 to remain in the position where it was manually moved.

In one arrangement, when the bottom bar 14 is manually moved a between a first predetermined distance and a second predetermined distance, such as between ¼ and 1 inch (also known as a micro tug) the microprocessor 240 responds by moving the bottom bar 14 up to the next predetermined stop position, such as 25% open if the shade is fully closed, or 50% open if the shade is 25% open, or 75% open if the shade is 50% open, and so on. Next, when the bottom bar 14 is manually moved a between a second predetermined distance and a third predetermined distance, such as between 1 inch and 2 inches (also known as a tug) the microprocessor 240 responds by moving the bottom bar 14 to a fully opened position (or a fully closed position). Next, when the bottom bar 14 is manually moved up to or more than a third predetermined distance, such as 2 inches (also known as a manual movement) the microprocessor 240 responds by merely tracking the position of the bottom bar 14 and allowing it to remain to where it was manually moved. This arrangement is more fully described in applicant's related U.S. Pat. No. 8,368,328 entitled “Method for operating a motorized roller shade” which is fully incorporated herein by reference including any and all related patents and patent applications.

The ability to manually move the bottom bar 14 without breaking the components of the shade 10 is accomplished by closely counterbalancing the weight profile of the shade material 16 with the torque profile produced by the various spring housings 200 connected to drive shaft 176. By closely counterbalancing the weight of the shade material 16, the motor 234 is required to carry minimal weight; or minimal torque is required from the motor 234 to open and close the shade 10. This arrangement allows for the motor 234 to be supplied with a power supply having a voltage that is substantially less than the rated voltage of the motor 234, such as half or less. As an example, when motor 234 is a 24V motor, 12 volts or less than 12 volts is supplied to the motor 234. This causes the motor 234 to rotate at a slower speed, and by harnessing Peukert's law, causes the batteries 250 to last longer. The slower rotational speed also means that less gearing, or a lower gear ratio is required out of gear box 274 connected between motor 234 and motor gear 258 to move the bottom bar 14 at the desired speed. This arrangement minimizes the back drive on motor 234 when the bottom bar 14 is manually moved. This arrangement is more fully described in applicant's related U.S. patent application Ser. No. 14/097,358 filed on Dec. 5, 2013 entitled High efficiency roller shade, which is fully incorporated by reference herein, including any related patent applications.

Harnessing this arrangement, with the counterbalancing, under powering of motor 234, the low gear ratio of gear box 274, and the battery power, among other features of the configuration, a slat-type shade is presented that is both manually movable and moved by motor 234. In addition, the shade 10 is operable by tugging as well.

Slat Clip:

A slat clip 270 is attached to the top slat 17 adjacent where each set of lift cords 18 and tilt ladders 19 connect to the slats 17. Slat clip 270 has an open interior that is sized and shaped to closely fit over the slat 17 and a pair of openings 272 in its end that receive one or both ends of the tilt ladder 19. Insertion of one or both of the ends of the tilt ladder 19 into openings 272 allows for easy and accurate forming of the top loop of the tilt ladder 19. In the arrangement shown, the upper end of tilt ladder 19 loop over the tilt spool 190, then to close the top end or loop of the tilt ladder 19, the ends of the tilt ladder 19 pass through openings 272 in slat clip 270 can be tied in a knot or crimped and held in place. In this way, the use of slat clip 270 allows the accurate and repeatable formation of a top loop of tilt ladder 19 without any abrasions, crimps, knots or any other obstruction.

Fishing Braid:

Conventionally fishing line was formed of a plastic monofilament material. Over time, with advances in materials and the development of ultra-high molecular weight fibers, various braided fishing lines (“braded lines” or “super lines”) have been developed.

One form of a braded line is made of ultra-high-molecular-weight polyethylene (UHMWPE, UHMW) which is a subset of the thermoplastic polyethylene. Also known as high-modulus polyethylene, (HMPE), or high-performance polyethylene (HPPE), it has extremely long chains, with a molecular mass usually between 2 and 6 million u. The longer chain serves to transfer load more effectively to the polymer backbone by strengthening intermolecular interactions. This results in a very tough material, with the highest impact strength of any thermoplastic presently made.

UHMWPE is odorless, tasteless, and nontoxic. It is highly resistant to corrosive chemicals except oxidizing acids; has extremely low moisture absorption and a very low coefficient of friction; is self-lubricating; and is highly resistant to abrasion, in some forms being 15 times more resistant to abrasion than carbon steel. Its coefficient of friction is significantly lower than that of nylon and acetal, and is comparable to that of polytetrafluoroethylene (PTFE, Teflon), but UHMWPE has better abrasion resistance than PTFE.

UHMWPE is synthesized from monomer of ethylene, which are bonded together to form the base polyethylene product. These ultra-high-molecular-weight polyethylene molecules are several orders of magnitude longer than those of familiar high-density polyethylene (HDPE) due to a synthesis process based on metallocene catalysts, resulting in UHMWPE molecules typically having 100,000 to 250,000 monomer units per molecule each compared to HDPE's 700 to 1,800 monomers.

UHMWPE can be processed by gel spinning, and sintering. In gel spinning a precisely heated gel of UHMWPE is extruded through a spinneret. The extrudate is drawn through the air and then cooled in a water bath. The end-result is a fiber with a high degree of molecular orientation, and therefore exceptional tensile strength. Gel spinning depends on isolating individual chain molecules in the solvent so that intermolecular entanglements are minimal. Entanglements make chain orientation more difficult, and lower the strength of the final product.

Dyneema® manufactured by DSM Dyneema LLC, 1101 Highway 27 South, Stanley, N.C. 28164, USA and Spectra® manufactured by Honeywell International Inc., 101 Columbia Road Morristown N.J. 07962, are lightweight high-strength oriented-strand gel spun through a spinneret. They have yield strengths as high as 2.4 GPa (350,000 psi) and specific gravity as low as 0.97 (for Dyneema SK75). High-strength steels have comparable yield strengths, and low-carbon steels have yield strengths much lower (around 0.5 GPa). Since steel has a specific gravity of roughly 7.8, this gives strength-to-weight ratios for these materials in a range from 8 to 15 times higher than steel. Strength-to-weight ratios for Dyneema are about 40% higher than for aramid.

Various manufacturers use these UHMWPE materials to produce braided fishing line. Examples include Fireline® manufactured by Berkley Inc., Highways 9 and 71, Spirit Lake Iowa 51360; SpiderWire® manufactured by Pure Fishing, Inc., 18th Street Spirit Lake Iowa 51360; and Power Pro® manufactured by Shimano American Corporation One Holland Irvine, Calif. 92618, among countless others.

In one arrangement, UHMWPE braided line or super line is used for lift cords 18. Use of this UHMWPE braided line for lift cord 18 over conventional strings provides many advantages. First, the UHMWPE braided line is much stronger than conventional strings and therefore a smaller diameter line can be used to support the weight of the bottom bar 14 and slats 17 which reduces the drag or friction on the system. In addition, because the UHMWPE braided line has an extremely low inherent coefficient of friction as well as self-lubricating properties, this provides for an extremely low friction arrangement which improves battery life. Second, the UHMWPE braided line is extremely abrasion resistant which helps to prevent unintentional breakage. Third, the UHMWPE braided line is resistant to light or chemical deterioration which helps to provide for a long useful life. Fourth, UHMWPE braided line has minimal stretch over time which allows for accurate setting of the length of the lift cords 18. As such, use of UHMWPE braided line as lift cord provides many advantages over conventional strings including improved battery life, durability, long life and breakage resistance among others.

Remote Control:

In one arrangement, a remote control 300 is provided that communicates with motor controller assembly 230 through wireless control signals which are received by the antenna 246 and transmitted to the microprocessor 240 of the motor controller 236. Remote control 300 is formed of any suitable size, shape and design. In one arrangement, as is shown, remote 300 includes an up button 302, a down button 304, a first position button 306 and a second position button 308. These buttons 302, 304, 306 and 308 control the height of shade 10; or said another way, the position of bottom bar 14. When pressed, up button 302 commands shade 10 to fully open, whereas when down button 304 is pressed the shade 10 is commanded to close. Similarly, when first position button 306 is pressed, shade 10 is commanded to move to a first predetermined position, such as 33% closed as an example, whereas when second position button 308 is pressed the shade 10 is commanded to move to a second predetermined position, such as 66% closed as an example. Any other number of predetermined position buttons are hereby contemplated for use such as one, three, four, five, six or more. These predetermined positions can be set to any point between fully opened and fully closed. These positions are arrived at by activating the motor 234 and counting the ticks or signals produced by the rotating magnet wheel 264 as the lift cords 18 are wrapped or unwrapped around the lift spools 186 until the desired position is achieved. To help identify the direction the button activates the shade 10, indicia such as up or down arrows are placed on the up button 302 and down button 304.

Also presented is a tilt button 310. Tilt button 310 controls the angular tilt of slats 17. Tilt button 310 includes a plurality of sensitivity zones, including an up zone 312 and a down zone 314. When pressed, up zone 312 or down zone causes motor 234 to rotate a predetermined amount to tilt slats 17 either up or down. When doing so, the microprocessor 240 tracks the number of rotations, signals or ticks from rotating magnetic wheel 264 thereby tracking the tilt of slats 17. In one arrangement each time the up zone 312 or down zone 314 is pressed the slats 17 are tilted a predetermined percentage between open and closed, such at 5% or 10% or 15% or 20% or the like. Alternatively each time the up zone 312 or down zone 314 is pressed the slats 17 are tilted a predetermined angle, such at 5 degrees or 10 degrees or 15 degrees or 20 degrees or the like. Any other amount of tilting or way of tracking the tilting of slats 17 is hereby contemplated for use.

Another functionality remote 300 includes is a dwell function. That is, when any of the buttons are pressed for less than a predetermined amount of time (such as ¼ of a second or ⅓ of a second, or ½ or a second, or the like) a first command is transmitted; whereas when the buttons are pressed for more than a predetermined amount of time (a dwell) a second command is transmitted. In the case of up zone 312 and down zone 314 when up zone 312 and down zone 314 are dwelled upon (a press longer than a predetermined amount of time) a command is sent that causes the slats 17 to fully tilt up or down.

Tilt button 310 may also include any other number of sensitivity zones, such as a middle zone 316, which when pressed or dwelled upon moves the slats 17 to a level position.

Remote 300 also includes a channel button 318 which when pressed toggles remote 300 between various channels, so as to allow remote 300 to control different shades 10 or different sets of shades, or other electronic devices. As the channel button 318 changes channels, indicators 320 illuminate to identify which channel has been selected.

Roman Shade:

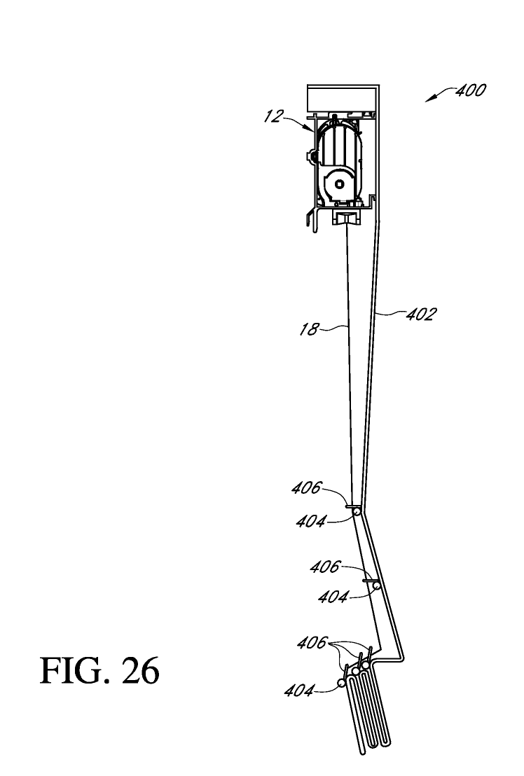

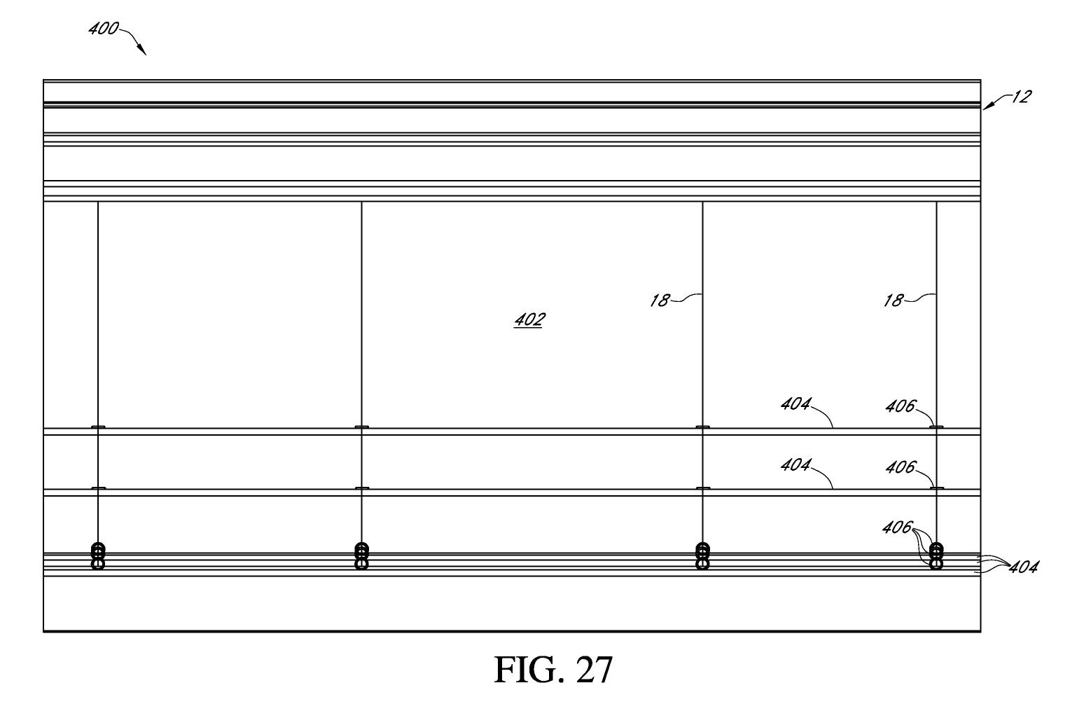

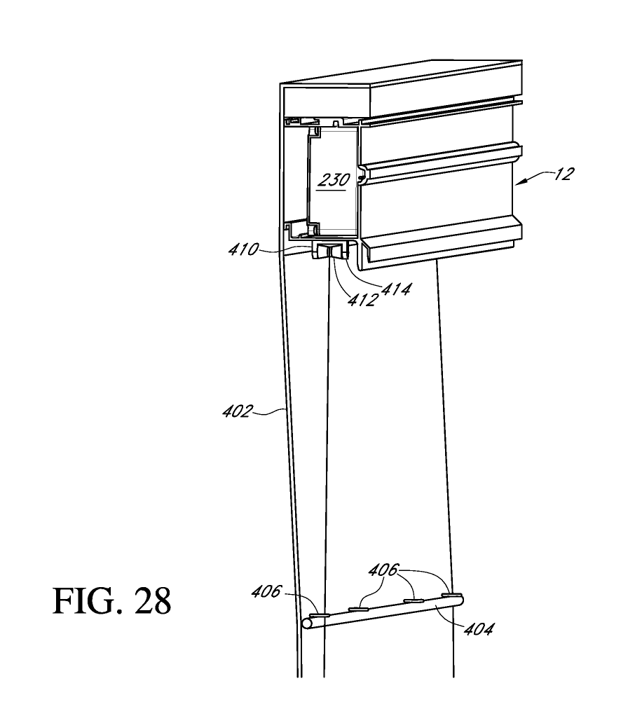

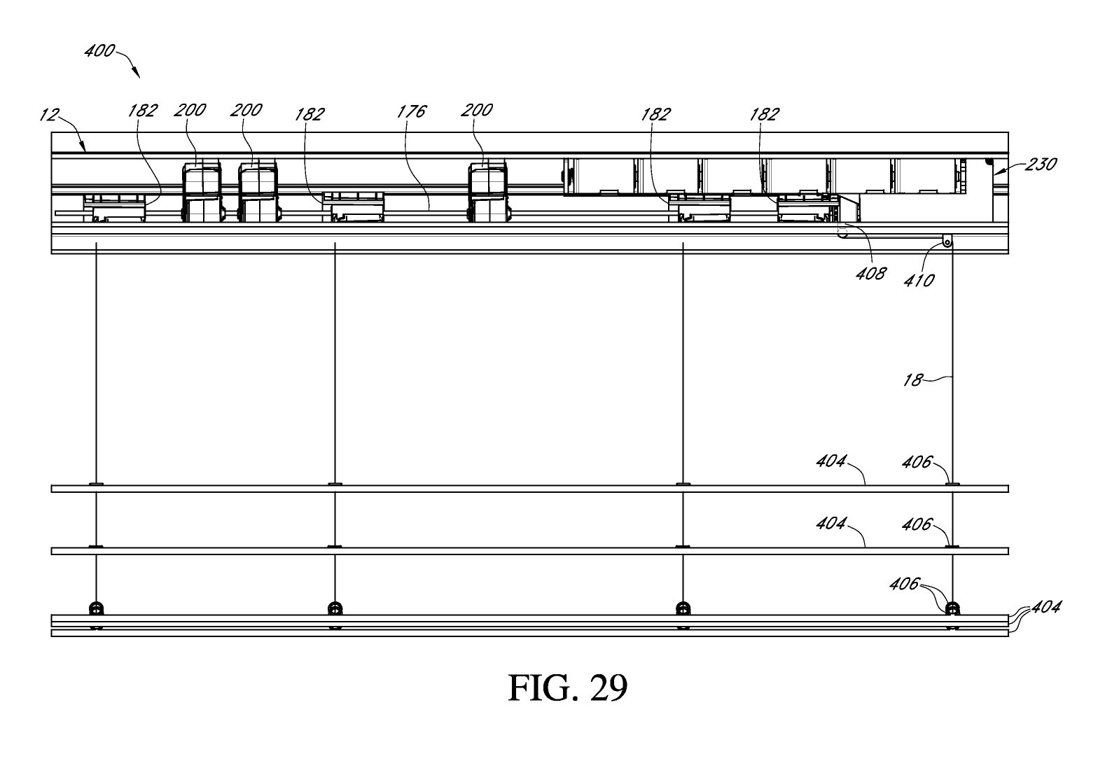

In an alternative arrangement, the shade system 10 presented herein is applied to Roman shade as is shown in FIGS. 26-29. In this arrangement the Roman shade system 400 includes header 12 and all other components as is described herein. Roman shade material 402 is connected to header 12. Roman shade material 402 is formed of a panel of fabric with a plurality of rigid horizontal support rods 404 that extend across a majority or the entirety of the side-to-side width of the Roman shade material 402. Horizontal support rods 404 are connected to the Roman shade material 402 at vertical intervals and are positioned in parallel spaced relation to one another. A guide 406 is connected to the Roman shade material 402 and/or the support rod 404 at or adjacent where each lift cord 18 crosses each support rod 404. Guides 406 are formed of any object or device that allows lift cords 18 to pass there through, such as an opening in Roman shade material 402, an opening in support rod 404, or in the arrangement shown, a guide ring. Lift cords 18 are connected to or affixed to the bottom most portion of the Roman shade material 402 or bottom most support rod 404, while lift cords 18 merely extend through the higher-positioned guides 406.

Lift cords 18 extend out of header 12 directly below each lift cord assembly 182. In the arrangement shown, as an example, the Roman shade 400 includes four lift cords 18. Three of these lift cords 18 extend straight down from lift cord assembly 182 and through guides 406. To make room for motor controller assembly 230, one of the outward most lift cord assemblies 182 is positioned inward a distance from where lift cord 18 extends through Roman shade material 402. To correct this lateral displacement, a first corner guide 408 is positioned approximately below where lift cord 18 extends through the bottom wall 130 of header 12 and a second corner guide 410 is positioned at the approximate position where lift cord 18 extends through Roman shade material 402. First corner guide 408 and second corner guide 410 are any form of a device through which lift cord 18 extends and causes lift cord 18 to change directions. In one arrangement, first corner guide 408 is an eyelet extending downward from the bottom surface of bottom wall 130 of header 12 and the second corner guide 408 is a roller 412 held in a bracket 414. In the arrangement shown, roller 412 is cylindrical in nature and slightly narrows approximately at its middle to ensure that lift cord 18 is maintained at or approximate to the middle of roller 412. In this way, room is provided for motor controller assembly 230 while allowing lift cord 18 to be positioned approximately at the outward edge of Roman shade material 402 below motor controller assembly 230.

In operation, as the motor 234 rotates to raise the shade, the lift spools 186 within lift cord assemblies 182 rotate thereby wrapping lift cords 18 around the lift spools 186. As the lift cords 18 are raised because the lift cords are tied to or affixed at or near the lower most portion of Roman shade material 402 or the lower most support rod 404, the bottom of Roman shade material 402 is simultaneously raised. As the bottom of Roman shade material 402 is raised the lift cords slide through guides 406. This continues until the bottom most support rod 404 or bottom most guide 406 reaches and engages the next upward positioned support rod 404 or guide 406 at which point both support rods 404 or guides 406 are raised together thereby creating a fold in the Roman shade material 402 between the adjacent support rods 404 or sets of guides 406. This process continues stacking iteration after iteration of support rods 404 or sets of guides 406 and forming folds in the Roman shade material 402 until the Roman shade material 402 is fully opened. At which point the process is reversed to close the Roman shade material 402 in the opposite manner.

Like the slat shade or Venetian shade presented above, the Roman shade material similarly responds to tugs and is manually movable as well as moved by motor 234 which provides for new functionality never before provided with respect to Roman shades.

In addition, negative gradient springs 210 within spring housings 200 are also used in association with the Roman shade material 402. The negative gradient springs impart less force as the shade extends down, or imparts less torque as the shade gets closer to the closed position. This allows the spring counterbalancing force to closely match the torque profile of raising the Roman shade material 402. This allows for less force to be used to raise and lower the shade, and it allows for manual movement and tugging of the Roman shade material 402 as well as motorized movement. This is because a lower gear ratio can be used which reduces the back drive on the motor 234 and the gear box 274.

Mounting Bracket:

Header 12 connects to the structure by removably attaching to a mounting bracket 420. Mounting bracket 420 is formed of any suitable size, shape and design. In the arrangement shown, mounting bracket 420 is connected to the structure by passing conventional fasteners through the mounting bracket 420 and into the structure. Once affixed to the structure, header 12 is snapped into place into mounting brackets 420.

From the above discussion it will be appreciated that an improved battery powered Venetian and Roman shade system and method of use has been presented that improves upon the state of the art.

That is, the improved battery powered Venetian and Roman shade system provides improved functionality over the prior art; provides improved aesthetics over the prior art; provides quiet function; provides long battery life; is durable; is relatively inexpensive; is easy to use; has a simple design; provides a long useful life; provides easy installation and access for maintenance and battery changes, among countless other improvements and advantages.

While the terms Roman shade and Venetian shade are used here, these terms are meant to describe these categories broadly, and not in a limiting sense. One of ordinary skill in the art would recognize that these terms describe shades formed of a panel of fabric and shades formed of a plurality of slats, respectively.

What is claimed:

1. A motor controller assembly for a Venetian shade having a plurality of slats comprising:
a housing;
a motor positioned within the housing, the motor having an output shaft;
a magnetic member operably connected to the motor such that rotation of the motor causes rotation of the magnetic member;
a controller electrically connected to the motor;
the controller having a microprocessor, memory, and a sensor positioned within sensing distance of the magnetic member;
wherein when the motor rotates the sensor senses rotation of the magnetic member and transmits signals to the microprocessor; and
wherein the microprocessor tracks the signals from the sensor and tracks the vertical position of the shade as well as the angle of tilt of the slats.

2. The motor controller assembly of claim 1 further comprising a gearbox connected the output shaft of the motor, wherein the gearbox changes the rotational speed of the output of the motor.

3. The motor controller assembly of claim 1 further comprising a battery holding assembly connected to the housing, the battery holding assembly housing a plurality of batteries.

4. The motor controller assembly of claim 1 wherein the magnetic member is a magnetic wheel connected to a secondary shaft of the motor.

5. The motor controller assembly of claim 1 wherein the sensor is one or more Hall Effect sensors.

6. The motor controller assembly of claim 1 wherein the microprocessor is learned to know the number signals from the sensor between a fully raised position of the shade and a fully lowered position of the shade.

7. The motor controller assembly of claim 1 wherein the microprocessor is learned to know the number of signals from the sensor between a fully upward tilted position of the shade and a fully downward titled position of the shade.

8. The motor controller assembly of claim 1 wherein the microprocessor is learned to know a predetermined number of signals from the sensor from a fully upward tilted position of the shade to a flat tilted position of the shade.

9. The motor controller assembly of claim 1 wherein the microprocessor is learned to know a predetermined number of signals from the sensor from a fully downwardly tilted position of the shade to a flat tilted position of the shade.

10. The motor controller assembly of claim 1 wherein the microprocessor is programmed to reverse the direction of the motor for a predetermined number of signals from the sensor after a vertical movement of the shade, thereby moving the slats to a flat tilted position.

11. The motor controller assembly of claim 1 wherein the microprocessor cuts power to the sensor in an asleep state to conserve power, and transmits power to the sensor in an awake state.

12. The motor controller assembly of claim 1 wherein the microprocessor recognizes and responds to a manual tug.

13. The motor controller assembly of claim 1 wherein the motor controller assembly is operatively connected to a drive shaft assembly having a plurality of lift spools and a plurality of tilt spools connected thereto, such that rotation of the motor simultaneously tilts the slats of the shade and raises or lowers the slats of the shade.

14. A method of operating a Venetian shade, the steps comprising:
providing a shade system having a header, a motor positioned within the header, shade material connected to the header and a bottom bar connected to the shade material, wherein the shade material is formed of a plurality of slats;
supporting the plurality of slats with a plurality of tilt ladders and a plurality of lift cords connected to the header and the bottom bar;
tracking the vertical position of the shade material as well as the angular tilt of the shade material with a microprocessor and a sensor;
driving the shade material vertically by activating the motor to open or close the shade material; and
establishing a reference position by finishing a vertical move by driving the shade material down a predetermined amount before moving the shade material up thereby moving the angular tilt of the shade material to a desired position from a known reference position.

15. The method of claim 14 wherein the angular tilt of the shade material is fully tilted in a first direction when the shade material is moved up more than a predetermined position.

16. The method of claim 14 wherein the angular tilt of the shade material is fully tilted in a second direction when the shade material is moved down more than a predetermined position.

17. The method of claim 14 wherein the vertical position and angular tilt of the shade material is tracked with a magnetic wheel and a Hall Effect sensor.

18. The method of claim 14 wherein the plurality of slats are vertically moved and angularly tilted by activating a single motor.

19. The method of claim 14 further comprising the step of connecting the plurality of tilt ladders to a plurality of tilt spools and connecting the plurality of lift cords to a plurality of lift spools, wherein the plurality of tilt spools and the plurality of lift spools are simultaneously rotated so as to simultaneously vertically adjust as well as angularly adjust the plurality of slats.

20. An architectural covering comprising:
a header;
the header having an open interior;
a driveshaft assembly positioned within the header;
the driveshaft assembly having a driveshaft and a first lift spool connected to the driveshaft;
a first modular spring housing positioned within the header;
the first modular spring housing having a storage spool and an output spool positioned within the first modular spring housing and a spring wound at least partially around the storage spool and the output spool;
wherein the driveshaft extends through the output spool such that rotation of the driveshaft rotates the output spool and transfers length of the spring between the output spool and the storage spool; and
wherein the storage spool and the output spool are positioned in vertical orientation to one another.

21. The architectural covering of claim 20 further comprising a motor controller assembly positioned within the header and operably connected to the drive shaft assembly.

22. The architectural covering of claim 20 further comprising a motor controller assembly positioned within the header and operably connected to the drive shaft assembly, wherein the motor controller assembly includes a motor and a battery holder assembly, wherein the motor and the battery holder assembly are positioned in vertical orientation to one another.

23. The architectural covering of claim 20 wherein the spring is a negative gradient spring.

24. The architectural covering of claim 20 wherein the spring is reverse wound.

25. The architectural covering of claim 20 further comprising a second modular spring housing positioned within the header and connected to the driveshaft.

26. A shade comprising:
a header;
a motor controller assembly positioned within the header and connected to a drive shaft;
a plurality of lift spools having a lift cord connected thereto, the plurality of lift spools connected to the drive shaft;
a plurality of slats suspended by a tilt ladder connected to the header;
wherein the lift cords extend through the plurality of slats; and
wherein the lift cords are formed of an ultra-high-molecular-weight polyethylene fiber thereby providing increased strength and abrasion resistance.

27. The Venetian shade of claim 26 further comprising a plurality of tilt spools connected to the drive shaft, wherein the lift spools and tilt spools rotate simultaneously with the drive shaft.

28. The Venetian shade of claim 26 further comprising a plurality of tilt spools connected to the drive shaft, wherein the lift spools and tilt spools rotate simultaneously with the drive shaft and wherein an upper end of the tilt ladder loops over a tilt spool.

29. A shade comprising:
a header;
the header having an open interior;
a motor controller positioned within the open interior of the header, the motor controller assembly having a motor and a plurality of batteries;
a drive shaft assembly positioned within the header;
the drive shaft assembly having a drive shaft rotatably connected to the motor controller assembly such that rotation of the motor rotates the drive shaft assembly;
a plurality of lift spools connected to the drive shaft at spaced intervals;
the plurality of lift spools having a lift cord;
a first corner connector and a second corner connector connected to the header; and
wherein a lift cord connected to a lift spool adjacent the motor controller assembly extends through the header, around the first corner connector laterally a distance before extending around the second corner connector and down the shade material so as to provide space for the motor controller assembly.

30. The shade of claim 29 wherein the first corner connector is an eyelet or a roller.

31. The shade of claim 29 wherein the second corner connector is an eyelet or a roller.

32. The shade of claim 29 further comprising a spring housing connected to the drive shaft, the spring housing having a negative gradient spring.

33. A Roman shade comprising;
a header;
a drive shaft assembly positioned within the header;
the drive shaft assembly having a drive shaft and a plurality of lift spools with lift cords connected to the lift spools;
a motor controller assembly positioned within the header and connected to the drive shaft assembly;
the motor controller assembly having a motor and a microprocessor, wherein rotation of the motor rotates the drive shaft;
Roman shade material connected to the header and the lift cords;
a first spring housing positioned within the header and connected to the drive shaft; and
a negative gradient spring positioned within the first spring housing.

34. The Roman shade of claim 33 further comprising a second spring housing positioned within the header and connected to the drive shaft.

35. The Roman shade of claim 33 wherein the first spring housing includes at least one alignment feature that mates with an alignment feature in the header that ensures proper orientation of the first spring housing.

36. The Roman shade of claim 33 wherein the first spring housing includes at least one off-center alignment feature that mates with an alignment feature in the header.

37. The Roman shade of claim 33 wherein the Roman shade material is movable by the motor as well as being manually movable.

38. The Roman shade of claim 33 wherein motor controller assembly moves the shade in response to a tug.

39. A Venetian shade comprising:
a header;
a drive shaft assembly positioned within the header;
the drive shaft assembly having a first lift spool and a first tilt spool;
the first tilt spool having a groove with a layer of compressible material positioned within the groove;
a first lift cord connected to the first lift spool;
a first tilt ladder connected to the first tilt spool;
a plurality of slats suspended in spaced relation by the first tilt ladder; and
wherein an upper end of the first tilt ladder loops over the first tilt spool such that rotation of the drive shaft causes the tilt cord to tilt the plurality slats.

40. The Venetian shade of claim 39 wherein the layer of compressible material positioned within the groove is an O-ring.

41. The Venetian shade of claim 39 wherein the layer of compressible material positioned within the groove is a plurality of O-rings.

42. The Venetian shade of claim 39 wherein the layer of compressible material positioned within the groove is polyurethane.

43. The Venetian shade of claim 39 wherein the layer of compressible material positioned within the groove is formed of approximately A90 Durometer material.

44. An architectural covering comprising:
a header;
a bottom bar;
shade material connected to and extending between the header and the bottom bar;
a first lift cord;
the first lift cord extending from the header, through the shade material and into the bottom bar;
the first lift cord connected to a first lift cord adjustment device connected to the bottom bar;
the first lift cord adjustment device having socket with a spool positioned within the socket;
the spool having a plurality of teeth in its periphery;
the first lift cord adjustment device having a flexible arm with at least one tooth positioned adjacent to the spool; and
wherein when pressure is applied to the first lift cord the at least one tooth of the flexible arm engage the teeth of the spool thereby preventing the spool from rotating.

45. The architectural covering of claim 44 wherein the first lift cord extends into the socket through an opening in the flexible arm and thereafter wraps around the spool.

46. The architectural covering of claim 44 wherein the spool is adjustable by inserting a tool through an opening in a bottom of the bottom bar.
